(19) United States
(12) Patent Application Publication
(10) Pub. No.: US 2025/0088296 A1
(43) Pub. Date: Mar. 13, 2025

(54) SATELLITE COMMUNICATION-ORIENTED GEOMETRY-BASED STOCHASTIC CHANNEL MODELING METHOD

(71) Applicants: Southeast University, Nanjing (CN); PURPLE MOUNTAIN LABORATORIES, Nanjing (CN)

(72) Inventors: Chengxiang WANG, Nanjing (CN); Zixin LI, Nanjing (CN); Hengtai CHANG, Nanjing (CN); Jie HUANG, Nanjing (CN)

(21) Appl. No.: 18/816,739

(22) Filed: Aug. 27, 2024

(30) Foreign Application Priority Data
Aug. 30, 2023 (CN) 2023110992661

(51) Int. Cl. H04B 17/391; H04B 17/309

(52) U.S. Cl. CPC H04B 17/3912; H04B 17/347

(57) ABSTRACT

A satellite communication-oriented geometry-based stochastic channel modeling method includes steps: S1: establishing a satellite channel simulation scenario, and setting scenario layout parameters; S2: initializing the trajectory and speed of a satellite and a receiving end; S3: calculating spatially consistent large-scale parameters, and calculating an effect of rainfall on the large-scale parameters; S4: calculating a path loss, a shadow fading, an atmospheric absorption, and a rainfall attenuation; S5: initializing the central positions of a cluster and a scatterer, and calculating the delay, angle and power of the cluster according to the geometric position information of the transmitting and receiving ends and the scatterer, to generate a channel coefficient; S6: updating the large-scale and small-scale parameters according to the movement of the transmitting and receiving ends and the birth-death process of the cluster, to generate a new channel coefficient; and S7: deriving the statistical characteristics of the channel, and performing simulation analysis.

### FIELD OF THE INVENTION

The present invention belongs to the technical field of channel modeling, and in particular, relates to a satellite communication-oriented geometry-based stochastic channel modeling method.

### DESCRIPTION OF RELATED ART

In recent years, the fifth generation (5G) mobile communication technology has begun to be commercially deployed around the world, and the research and development of the sixth generation (6G) mobile communication technology is also in full swing. The 6G vision can be summarized as “global-coverage, all-spectra, full-application, full-sense, full-digitalization, and strong security”. It aims to provide higher communication rates, more user connections, and wider network coverage on the basis of 5G, providing users with a more intelligent, secure, and immersive “Everything Connected” experience. In order to achieve deep global coverage, 6G will expand from ground mobile communications to a space-air-ground-sea integrated communication network, of which satellite communication serves an indispensable part. Satellite communication has the advantages of large coverage area, long communication distance, and suitability for a variety of services. It can realize communication with fixed or mobile terminals and is widely used in application scenarios such as navigation, earth observation, and broadcasting. With the rapid development of the space-air-ground-sea integrated network, 6G-oriented satellite communication networks require larger capacity and higher service quality to provide users with ubiquitous connectivity. Typical applications include satellite Internet of Things, satellite-to-cellular service, fixed network backhaul, connected cars, emergency safety communications, aircraft broadcasting, maritime communications, and so on.

Depending on whether the satellite is stationary relative to the earth, satellites can be divided into geostationary earth orbit (GEO) satellites and non-geostationary earth orbit (NGEO) satellites; and according to the altitude of the satellite orbit, satellites can be divided into high earth orbit (HEO) satellites, medium earth orbit (MEO) satellites, and low earth orbit (LEO) satellites. GEO satellites are typical HEO satellites, while LEO and MEO satellites are NGEO satellites. Low-orbit satellites orbit at an altitude of 500-2000 km and have the advantages such as low propagation delay, small size and low signal loss, and are expected to significantly improve the communication speed and energy efficiency. However, in order to achieve global coverage, multiple satellites are required for networking. For example, the StarLink system consists of 1,584 satellites deployed at an altitude of 550 km. MEO satellites have an altitude of 5,000-12,000 km, orbiting at a lower speed, and each has a larger communication range. Satellites at an altitude above 20,000 km are generally HEO satellites. GEO satellites with an altitude of 36,000 km are typical HEO satellites, having an advantage that only three satellites are enough to cover the entire earth, and there is almost no need to track the direction of the satellite. However, the high orbital altitude of the satellite leads to very high free space path loss.

The 6G-oriented satellite communication network shows a trend of evolving towards broadband and Internet. It can be seen from the communication satellites currently in orbit and planned to be launched that future satellite communication systems will adopt millimeter-wave frequency bands such as Ka and Q bands to achieve high-speed communication and broadband digital transmission. At the same time, they will continue to use low-frequency bands that are not easily affected by clouds and rainy weather, to compensate for the shortcomings of the millimeter-wave bands susceptible to weather factors such as rainfall, and provide higher-quality communication services through multiple complementary frequency bands. In terms of orbital altitude, large-scale NGEO broadband Internet constellations are the current focus of global aerospace development, and high-throughput GEO satellites also gain continuous attention thanks to their advantages in coverage, capacity and bandwidth cost. Channel modeling lays a foundation for the design, optimization and adjustment of a communication system, and plays a crucial role in all aspects of a wireless communication system. In view of the development trend that 6G satellite communication networks will adopt multiple frequency bands for communication and satellites at multiple orbital altitudes, a general satellite channel model suitable for different frequency bands and different orbital altitudes needs to be proposed.

### SUMMARY OF THE INVENTION

The present invention aims to provide a satellite communication-oriented geometry-based stochastic channel modeling method, which can characterize different channel characteristics of satellite communication systems covering S-band to millimeter-wave band, and is suitable for various satellite trajectories and receiving-end environments to solve the technical problems mentioned in the background technology.

To solve the above-mentioned technical problem, the specific technical solution of the present invention is as follows:

A satellite communication-oriented geometry-based stochastic channel modeling method, wherein the channel modeling method comprises the following steps:
Step S1: establishing a satellite communication-oriented geometry-based stochastic channel model and a satellite channel simulation scenario corresponding to the model, and setting scenario layout parameters;
Step S2: initializing the trajectory and speed of a satellite and a ground user;
Step S3: calculating spatially consistent large-scale parameters, and the effect of rainfall on the large-scale parameters;
Step S4: calculating a path loss, a shadow fading, an atmospheric absorption and a rainfall attenuation;
Step S5: initializing the central positions of a cluster and a scatterer, and calculating the delay, angle and power of the cluster according to the geometric position information of the transmitting and receiving ends and the scatterer, to generate a channel coefficient;
Step S6: updating the large-scale and small-scale parameters according to the movement of the transmitting and receiving ends and the birth-death process of the cluster, to generate a new channel coefficient; and
Step S7: deriving the statistical characteristics of the channel, and performing simulation analysis.

Further, the step S1 includes the following specific steps:
Step S101: the transmitting end of the model is a satellite, the receiving end is a mobile ground user, the orbital altitude hₛₐₜ of the satellite needs to be pre-set according to the requirements of the simulation environment, and the environment of the ground mobile receiving end also needs to be pre-set as a dense city, a city, a suburb, or a rural environment;
Step S102: both the transmitting end and the receiving end of the model are equipped with a antenna array, so the spacing and angle parameters of the antenna array need to be initialized, wherein the antenna array is a uniformly distributed linear array; the transmitting end has a total of P antennas, Aₚ^{T} denotes the pth antenna, β_{A}^{T} denotes an azimuth angle of the transmitting-end antenna array, β_{E}^{T} denotes an elevation angle of the transmitting-end antenna array, and a spacing between the antennas is δ^{T}; and the receiving end has a total of Q antennas, A_{q}^{T} denotes the qth antenna, β_{A}^{R} denotes an azimuth angle of the receiving-end antenna array, β_{E}^{R} denotes an elevation angle of the receiving-end antenna array, and a spacing between the antennas is δ^{R}.
Step S103: the system parameters of the model further comprise a carrier frequency f_{c}, and a rainfall rate.

Further, the step S2 specifically includes:
Step S201: the initial position of the satellite is determined together by the orbital altitude hₛₐₜ, elevation θₛₐₜ and azimuth φₛₐₜ; satellites are divided into GEO satellites and NGEO satellites according to whether the satellites are stationary relative to the earth; the GEO satellites are stationary relative to the ground; under the Earth's gravity, the NGEO satellites orbit the earth in an elliptical trajectory; first, an elliptical orbital plane of the satellite is determined by setting the following five parameters: a length a of the semi-major axis of the elliptical orbit; an eccentricity e of the elliptical orbit, wherein if the eccentricity e is set to 0, the elliptical orbit is reduced to a circular orbit; the angle between the orbit and the equatorial plane is an orbital plane inclination ι; the longitude of the point where the orbit crosses the equatorial plane upward is called a right ascension of the ascending node Ω; the direction of the ellipse on the orbital plane is determined by an argument of perigee ω of an angle between the orbital perigee and the ascending node; a true Anomaly υ represents an angle swept by moving along the orbit from the perigee; after determination of the orbital plane, the specific position of the satellite in the elliptical orbit can be determined via υ; the satellite trajectory is determined together by a time-varying right ascension of the ascending node Ω(t) caused by orbital perturbations and a time-varying argument of perigee ω(t) as well as a change υ(t) in the true anomaly caused by the Earth's gravity; at each moment, in the Cartesian coordinate system with the geocenter as the origin, the position coordinates (xₛₐₜ, yₛₐₜ, zₛₐₜ) of the moving satellite are expressed as:

$${x}_{sat} = R ( t ) \cdot \{ cos ( ω ( t ) + v ( t ) ) \cdot cos Ω ( t ) - sin ( ω ( t ) + v ( t ) ) \cdot sin Ω ( t ) \cdot cos ( ι ) \}$$

$${y}_{sat} = R ( t ) \cdot \{ cos ( ω ( t ) + v ( t ) ) \cdot sin Ω ( t ) - sin ( ω ( t ) + v ( t ) ) \cdot cos Ω ( t ) \cdot cos ( ι ) \}$$

$${z}_{sat} = R ( t ) \cdot sin ( ω ( t ) + v ( t ) ) \cdot sin ( ι )$$

where, R(t) is a distance from the geocenter to the satellite at each moment, calculated as:

$$R ( t ) = \frac{a \cdot {( 1 - e )}^{2}}{1 + e \cdot cos v ( t )}$$

the in-orbit speed of a satellite in an elliptical orbit is time-varying, given by

$$\sqrt{{μ}_{E} ( \frac{2}{R ( t )} - \frac{1}{a} )}$$

km/s; when the eccentricity e of the elliptical orbit is set to 0, the elliptical orbit is reduced to a circular orbit with a constant speed \sqrt{μ_{E}/a} km/s, where, μ_{E} is a gravitational constant, with a value of 3.986012×10⁵ km³/s²; and
Step S202: the receiving end is set as a moving vehicle, of which a speed vᵣₓ and a moving trajectory are set.

Further, the step S3 includes the following specific steps:
Step S301: generating spatially consistent large-scale parameters according to the frequency, environment and satellite elevation: large-scale fading PL, shadow fading SH, delay spread DS, azimuth angular spread of arrival ASA, elevation angular spread of arrival ESA, Rician K-factor KF, and cross-polarization ratio XPR, wherein for each large-scale parameter to be calculated, the following general formula is employed:

$$V = {V}_{μ} + {V}_{ϵ} \cdot {log}_{10} d + {V}_{γ} \cdot {log}_{10} {f}_{GHz} + {V}_{α} \cdot {log}_{10} {α}_{rad} + X ( {V}_{σ} + {V}_{δ} \cdot {log}_{10} {f}_{GHz} + {V}_{β} \cdot {log}_{10} {α}_{rad} )$$

where, the parameters V_{μ}, V_{∈}, V_{γ}, V_{α}, V_{σ}, V_{δ} and V_{β} are related to the environment, d is a distance between the transmitting end and the receiving end, f_{GHz} is a carrier frequency, α_{rad} is a satellite elevation, and X is a spatially consistent normally distributed random variable with a mean of 0 and a variance of 1; and
Step S302: setting a rainfall rate to R, wherein the effect of rainfall on channel multipath fading is reflected in the changes of the parameters KF, DS, ASA and ESA caused by the rainfall rate; the model employs the parameter ξ_{KF} to denote the effect of the rainfall rate on the Rician K-factor, and the Rician K-factor KF_{R} affected by the rainfall is expressed as:

$${KF}_{R} = KF - R \cdot {ξ}_{KF}$$

the model assumes that the effect of rainfall on multipath is linear, using the parameters ξ_{DS}, ξ_{ASA} and ξ_{ESA} to measure the effect of rainfall on a cluster; the delay spread DS_{R} and angular spread ASA_{R} and ESA_{R} affected by rainfall are expressed as:

$${DS}_{R} = DS ( 1 + R \cdot {ξ}_{DS} )$$

$${ASA}_{R} = ASA ( 1 + R \cdot {ξ}_{ASA} )$$

$${ESR}_{R} = ESA ( 1 + R \cdot {ξ}_{ESA} )$$

in addition, an increase in the number of multipaths during rainfall is modeled as an increase in the number of clusters; and the model models the newly added clusters Nᵣₐᵢₙ due to rainfall in a Poisson distribution:

$${N}_{rain} ∼ P ( R \cdot {ξ}_{λ} )$$

where, P represents a Poisson distribution, and ξ_{λ} represents an expectation of the distribution.

Further, the step S4 includes the following specific steps:
Step S401: calculating a free path loss PL, and modeling as a log-distance path loss model, wherein the shadow fading SF follows a log-normal distribution;
Step S402: calculating the atmospheric absorption A_{R}, setting the receiving-end height equal to the sea level height, and taking the mean annual global reference atmosphere values as the environmental parameters: temperature T, dry air atmospheric pressure p, water vapor density ρ and water vapor pressure e, wherein A_{G} is expressed as:

$${A}_{G} = \frac{{A}_{zeni th} ( f )}{sin ( θ )}$$

where, θ is the satellite elevation, and A_{zenith}(f) is the zenith angle attenuation; and
Step S403: calculating the large-scale fading caused by rainfall at a specific rainfall rate, and calculating a rainfall attenuation coefficient with reference to the Crane model, the rainfall attenuation expressed as:

$${A}_{R} = {a}_{Crane} {R}^{{b}_{Crane}} \cdot \frac{{h}_{R}}{sin {θ}_{sat}}$$

where, h_{R} denotes the rainfall height, θₛₐₜ denotes the satellite elevation, the parameters a_{Crane} and b_{Crane} are Crane model parameters which are obtained from discrete calculations and can be derived by curve fitting to a power law coefficient; and a relationship between the rainfall height h_{R} and the zero-degree isotherm h₀ is given by:

$${h}_{R} = {h}_{0} + 0.36$$

where, the unit thereof is km, and h₀ is related to the longitude and latitude of the earth.

Further, the step S5 specifically includes:
Step S501: calculating a delay τₙ of each cluster, a receiving-end azimuth angle φₙ^{a} and a receiving-end elevation angle θₙ^{a} using the large-scale parameters calculated in Step S301, wherein the delay of the cluster follows a unilateral exponential distribution, and an initial value thereof is calculated as:

$${\tilde{τ}}_{l} = - ln \{ {X}_{l}^{τ} ( {x}_{t} , {y}_{t} , {z}_{t} , {x}_{r} , {y}_{r} , {z}_{r} ) \}$$

where, (xₜ, yₜ, zₜ) denotes the transmitting-end coordinates, and (xᵣ, yᵣ, zᵣ) denotes the receiving-end coordinates;
and scaled by the large-scale parameters as:

$${τ}_{l} = {\tilde{τ}}_{l} \cdot \frac{1}{F} \cdot {\sum }_{f = 1}^{F} \frac{{DS}_{f}}{\tilde{{DS}_{f}}}$$

where, f=1 . . . F denotes F carrier frequencies, [symbol] _{f} is an initial delay spread, and DS_{f} is a large-scale parameter;
the initial value of angle ϕ̅ₗ follows a uniform distribution and is scaled by a large-scale parameter:

$${ϕ}_{l} = arg exp \{ j \cdot {\tilde{ϕ}}_{l} \cdot s \} , s = \frac{1}{F} \cdot {\sum }_{f = 1}^{F} \frac{A {S}_{f}}{\tilde{{AS}_{f}}} , s < \{ \begin{matrix}3. , azimuth angle \\ 1.5 , elevation angle\end{matrix}$$

where, [symbol] _{f} is an initial delay spread, AS_{f} is the large-scale parameter, and s is a scale;
Step S502: calculating the polar coordinates of each cluster with the receiving end as the origin via a geometrical relationship, according to the basic information of the cluster generated in Step S501:

$${( {d}_{n}^{T} )}^{2} = {( {d}_{n}^{R} )}^{2} + {d}^{2} - 2 \cdot {d}_{n}^{R} \cdot d \cdot cos {α}_{n}$$

where dₙ^{T} is the distance from the nth cluster to the transmitting end at the initial moment, dₙ^{R} is the distance from the nth cluster to the receiving end, and d is the distance between the transmitting end and the receiving end; the angle αₙ is the angle between a unit vector of the receiving end pointing to the nth cluster and a unit vector of the receiving end pointing to the transmitting end; with the given elevation angle φₙ^{a} and θₙ^{a} of the nth scatterer and the three-dimensional angular information φₛₐₜ and θₛₐₜ of the transmitting end of the satellite, a unit vector (\hat{x}ₙ, ŷₙ, \hat{z}ₙ) of the receiving end pointing to the scatterer and a unit vector (\hat{x}ₛₐₜ, ŷₛₐₜ, \hat{z}ₛₐₜ) of the receiving end pointing to the transmitting end can be calculated, and the angle αₙ can be calculated by the following equation:

$$\{ \begin{matrix}{\hat{x}}_{n} = cos {θ}_{n}^{a} cos {φ}_{n}^{a} \\ {\hat{y}}_{n} = cos {θ}_{n}^{a} sin {φ}_{n}^{a} \\ {\hat{z}}_{n} = sin {θ}_{n}^{a}\end{matrix} , \{ \begin{matrix}{\hat{x}}_{sat} = cos {θ}_{sat} cos {φ}_{sat} \\ {\hat{y}}_{sat} = cos {θ}_{sat} sin {φ}_{sat} \\ {\hat{z}}_{sat} = sin {θ}_{sat}\end{matrix}$$

$$cos {α}_{n} = \frac{{\hat{x}}_{n} {\hat{x}}_{sat} + {\hat{y}}_{n} {\hat{y}}_{sat} + {\hat{z}}_{n} {\hat{z}}_{sat}}{\vert ( {\hat{x}}_{n} , {\hat{y}}_{n} , {\hat{z}}_{n} ) \vert \vert ( {\hat{x}}_{sat} , {\hat{y}}_{sat} , {\hat{z}}_{sat} ) \vert}$$

and substituting αₙ in the first equation in Step S502, to obtain the central position (dₙ^{R}, φₙ^{a}, θₙ^{a}) of the cluster in the polar coordinates with the receiving end as the origin;
Step S503: calculating the geometric positions of the scatterers in each cluster, wherein the scatterers in the model are in a three-dimensional elliptical Gaussian distribution around the center of the cluster; the three dimensions of the scatterer follow a Gaussian distribution with a standard deviation of σₓ, σ_{y}, σ_{z}, and in the three-dimensional Cartesian coordinate system with the receiving end as the origin, the coordinates (xₙ_{ₘ}, yₙ_{ₘ}, zₙ_{ₘ}) of each scatterer are calculated by the following equation:

$$[ \begin{matrix}{x}_{{n}_{m}} \\ {y}_{{n}_{m}} \\ {z}_{{n}_{m}}\end{matrix} ] = [ \begin{matrix}cos ( {φ}_{n} ) & - sin ( {φ}_{n} ) & 0 \\ sin ( {φ}_{n} ) & cos ( {φ}_{n} ) & 0 \\ 0 & 0 & 1\end{matrix} ] \cdot [ \begin{matrix}cos ( {θ}_{n} ) & 0 & - sin ( {θ}_{n} ) \\ 0 & 1 & 0 \\ sin ( {θ}_{n} ) & 0 & cos ( {θ}_{n} )\end{matrix} ] \cdot [ \begin{matrix}{x}^{′} + {d}_{n}^{R} \\ {y}^{′} \\ {z}^{′}\end{matrix} ]$$

$$p ( {x}^{′} , {y}^{′} , {z}^{′} ) = \frac{exp ( - \frac{{x}^{′2}}{2 {σ}_{x}^{2}} - \frac{{y}^{′2}}{2 {σ}_{y}^{2}} - \frac{{z}^{′2}}{2 {σ}_{z}^{2}} )}{{( 2 π )}^{3 / 2} {σ}_{x} {σ}_{y} {σ}_{z}}$$

Step S504: calculating the path length d_{qp,n}_{ₘ}(t) and delay τ_{qp,n}_{ₘ}(t) of each path according to the geometric positions of the scatterers determined in Step S503, wherein the model needs to consider the delay resolution of subpaths, which is, with the changes of power in time domain and frequency domain taken into account, calculated as:

$${P}_{qp , {n}_{m} , {f}_{c}} ( t , f ) = exp ( - {τ}_{qp , {n}_{m}}^{′} ( t ) {g}_{{f}_{c}}^{DS} ) 1 {0}^{- \frac{{Z}_{n}}{10}} {( \frac{f}{{f}_{c}} )}^{γ}$$

where, τ′_{qp,n}_{ₘ} (t) is a relative delay of each subpath, Zₙ is a cluster shadow calculated for each cluster, which follows a Gaussian distribution with a mean of 0;

$${( \frac{f}{{f}_{c}} )}^{γ}$$

models the frequency-dependent characteristic of power in a millimeter-wave high-bandwidth channel, and γ is related to frequency; g_{f}_{_{c}}^{DS} is a delay spread scale factor, which is, with different calculation methods employed in single-frequency point modeling and multi-frequency point modeling, expressed as:

$${g}_{{f}_{c}}^{DS} = \{ \begin{matrix}- 1.5 \cdot ln \{ 1.2 \cdot \frac{{DS}_{{f}_{c}}}{max ( {DS}_{{f}_{c}} ) + min ( {DS}_{{f}_{c}} )} - 0.15 \} , multiple frequency points \\ \frac{{r}_{τ} - 1}{{r}_{τ} DS} , single frequency point\end{matrix}$$

where, DS_{f}_{_{c}} denotes the large-scale parameters at different frequencies, DS is the delay spread, and r_{τ} is a delay distribution scale factor; and
Step S505: calculating the channel coefficient according to the generated parameters:

$$H = {[ PL \cdot SH \cdot {A}_{G} \cdot {A}_{R} ]}^{1 / 2} \cdot {h}_{qp , {f}_{c}} ( t , τ )$$

where, the large-scale fading [PL·SH·A_{G}·A_{R}]^{1/2} is calculated in Step 4, and the small-scale fading h_{qp,f}_{_{c}}(t, τ) is expressed as:

$${h}_{qp , {f}_{c}} ( t , τ ) = \sqrt{\frac{{K}_{R} ( t )}{{K}_{R} ( t ) + 1} {h}_{qp , {f}_{c}}^{L} ( t , τ )} + \sqrt{\frac{1}{{K}_{R} ( t ) + 1} {h}_{qp , {f}_{c}}^{N} ( t , τ )}$$

where, K_{R}(t) is the Rician K-factor that varies with time, h_{qp,f}_{_{c}}^{L}(t,τ) is the channel impulse response of a LOS path, and h_{qp,f}_{_{c}}^{N}(t,τ) is the channel impulse response of a NLOS path, respectively expressed as:

$${h}_{qp , {f}_{c}}^{L} ( t , τ ) = {[ \begin{matrix}{F}_{q , V} ( {ϕ}_{E , L}^{R} ( t ) , {ϕ}_{A , L}^{R} ( t ) ) \\ {F}_{q , H} ( {ϕ}_{E , L}^{R} ( t ) , {ϕ}_{A , L}^{R} ( t ) )\end{matrix} ]}^{T} \cdot [ \begin{matrix}{e}^{j {θ}_{L}^{VV}} & 0 \\ 0 & - {e}^{j {θ}_{L}^{HH}}\end{matrix} ] \cdot {F}_{r} \cdot [ \begin{matrix}{F}_{p , V} ( {ϕ}_{E , L}^{T} ( t ) , {ϕ}_{A , L}^{T} ( t ) ) \\ {F}_{p , H} ( {ϕ}_{E , L}^{T} ( t ) , {ϕ}_{A , L}^{T} ( t ) )\end{matrix} ] \cdot {e}^{j 2 π {f}_{c} {τ}_{qp}^{L} ( t )} δ ( τ - {τ}_{qp}^{L} ( t ) )$$

$${h}_{qp , {f}_{c}}^{N} ( t , τ ) = {\sum }_{n = 1}^{{N}_{qp} ( t )} {\sum }_{m = 1}^{{M}_{n} ( t )} {[ \begin{matrix}{F}_{q , {f}_{c} , V} ( {ϕ}_{E , {n}_{m}}^{R} ( t ) , {ϕ}_{A , {n}_{m}}^{R} ( t ) ) \\ {F}_{q , {f}_{c} , H} ( {ϕ}_{E , {n}_{m}}^{R} ( t ) , {ϕ}_{A , {n}_{m}}^{R} ( t ) )\end{matrix} ]}^{T} \cdot [ \begin{matrix}{e}^{j {θ}_{{n}_{m}}^{VV}} & \sqrt{{μκ}_{{n}_{m}}^{- 1} ( t )} {e}^{j {θ}_{{n}_{m}}^{HV}} \\ \sqrt{{κ}_{{n}_{m}}^{- 1} ( t )} {e}^{j {θ}_{{n}_{m}}^{HV}} & \sqrt{μ} {e}^{j {θ}_{{n}_{m}}^{HH}}\end{matrix} ] \cdot {F}_{r} \cdot [ \begin{matrix}{F}_{p , {f}_{c} , V} ( {ϕ}_{E , {n}_{m}}^{T} ( t ) , {ϕ}_{A , {n}_{m}}^{T} ( t ) ) \\ {F}_{p , {f}_{c} , H} ( {ϕ}_{E , {n}_{m}}^{T} ( t ) , {ϕ}_{A , {n}_{m}}^{T} ( t ) )\end{matrix} ] \cdot \sqrt{{P}_{qp , {n}_{m} , {f}_{c}} ( t )} \cdot {e}^{j 2 π {f}_{c} {τ}_{qp} , {n}_{m} ( t )} δ ( τ - {τ}_{qp , {n}_{m}} ( t ) )$$

where, [·]^{T} denotes transpose, F_{p(q),f}_{_{c}}^{,V} is a horizontal polarization antenna pattern of the transmitting and receiving antennas, and F_{p(q),f}_{_{c}}^{,H} is an horizontal polarization antenna pattern; κₙ_{ₘ}(t) is a cross-polarization ratio, μ denotes co-polarization imbalance, ϕ_{A,L}^{T}(t) is an azimuth angle of departure corresponding to the LOS path at the moment t stretching from A₁^{T} to A₁^{R}, ϕ_{E,L}^{T}(t) is an elevation angle of departure corresponding to the LOS path at the moment t stretching from A₁^{T} to A₁^{R}, and ϕ_{A,L}^{R}(t) is an azimuth angle of arrival corresponding to the LoS path at the moment t stretching from A₁^{T} to A₁^{R}; ϕ_{E,L}^{R}(t) is an elevation angle of arrival corresponding to the LoS path at the moment t stretching from A₁^{T} to A₁^{R}, θ_{L}^{VV} and θ_{L}^{HH} represent the initial phases of the LOS path, θₙ_{ₘ}^{HH}, θₙ_{ₘ}^{HV}, θₙ_{ₘ}^{VV} and θₙ_{ₘ}^{VH} represent the initial phases of the NLOS path, which are random variables that follow a uniform distribution between 0 and 2π; Faraday rotation matrix Fᵣ refers to the rotation of a polarization plane caused by the propagation of electromagnetic waves through the ionosphere in the satellite scenario, which needs to be considered in communication scenarios below 10 GHZ; P_{qp,n}_{ₘ}_{,f}_{_{c}}(t) is the subpath power calculated in Step S504, τ_{qp}^{L}(t) is the absolute delay of the Mth of LOS subpath of LOS, which can be calculated by dividing the distance between the transmitting and receiving antennas q,p by the speed of light, and τ_{qp,n}_{ₘ}(t) is the absolute delay of the mth subpath in the nth cluster, which can be calculated by dividing the length of the nₘth subpath between the transmitting and receiving antennas q, p by the speed of light.

Further, the step S6 includes the following specific steps:
Step S601: introducing a survival probability Pₛᵤᵣᵥ(Δt, Δf) of the cluster in the time-frequency domain, with the birth and death of the cluster in the time domain and frequency domain taken into account:

$${P}_{surv} ( Δ t , Δ f ) = {P}_{surv} ( Δt ) \cdot {P}_{surv} ( Δ f ) = {e}^{- {λ}_{R} \frac{{v}_{rx} Δ t}{{D}_{c}^{T}}} \cdot {e}^{- {λ}_{R} \frac{Δ f}{{D}_{c}^{F}}}$$

where, Pₛᵤᵣᵥ(Δt) is the time-domain cluster survival probability, Pₛᵤᵣᵥ(Δf) is the frequency-domain cluster survival probability, Δt is a time interval, Δf is a frequency interval, the birth-death process of the cluster is described jointly by a generation rate λ_{G} and a disappearance rate λ_{R} of the cluster, these two parameters are related to the environmental characteristics of the communication scenario and the antenna pattern; parameters D_{c}^{T}, D_{c}^{F} are scenario-related factors in the time domain and frequency domain, obtained by channel measurement in a specific scenario; and an expected number [symbol] {N_{new}} of new clusters is calculated as; and

$$𝔼 \{ {N}_{new} \} = \frac{{λ}_{G}}{{λ}_{R}} [ 1 - {P}_{surv} ( Δ t , Δ f ) ]$$

Step S602: updating the channel coefficient according to the step S5, with the movement of the transmitting and receiving ends and the clusters as well as the birth and death of the clusters taken into account.

Further, the step S7 specifically includes:
Step S701: calculating an effective path loss, which consists of three parts: free space path loss PL, atmospheric absorption A_{G} and rainfall attenuation A_{R}, wherein the three large-scale fading components do not change rapidly with time, showing a relatively constant trend, and the sum of the three is defined as the effective path loss: PL_{eff}=PL+A_{G}+A_{R}
Step S702: calculating the root-mean-square (RMS) delay spread of the channel, expressed as:

$${D}_{qp , rms} ( t ) = \sqrt{\frac{{\int }_{- ∞}^{∞} {( τ - {μ}_{qp , τ} ( t ) )}^{2} {P}_{qp , {n}_{m} , {f}_{c}} ( t , τ ) d τ}{{\int }_{- ∞}^{∞} {P}_{qp , {n}_{m} , {f}_{c}} ( t , τ ) d τ}}$$

where, τ is the delay, and the average delay can be expressed

$${μ}_{qp , τ} ( t ) = \frac{{\int }_{- ∞}^{∞} τ \cdot {P}_{qp , {n}_{m} , {f}_{c}} ( t , τ ) d τ}{{\int }_{- ∞}^{∞} {P}_{qp , {n}_{m} , {f}_{c}} ( t , τ ) d τ} ;$$

Step S703: calculating a time-frequency correlation function of the channel, with a theoretical value expressed as:

$${R}_{q p} ( t , f ; Δ t , Δ f ) = 𝔼 [ {H}_{q p} ( t , f ) {H}_{q p}^{*} ( t + Δ t , f + Δ f ) ]$$

where, [symbol] [·] represents the expectation, [·]* represents the conjugate of a complex number, H_{qp} represents a channel transfer function, which is obtained by Fourier transform of the channel impulse response; without considering the correlation between the LOS path and the NLOS path, the time-frequency correlation function is expressed as the sum of the time-frequency correlation functions of the paths:

$${R}_{q p} ( t , f ; Δ t , Δ f ) = {R}_{q p}^{L} ( t , f ; Δ t , Δ f ) + {R}_{q p}^{N} ( t , f ; Δ t , Δ f )$$

where, R_{qp}^{L}(t, f; Δt, Δf) represents the time-frequency correlation function of the LOSpath, expressed as:

$${R}_{q p}^{L} ( t , f ; Δ t , Δ f ) = 𝔼 [ \sqrt{\frac{{K}_{R} ( t )}{{K}_{R} ( t ) + 1} \cdot \frac{{K}_{R} ( t + Δ t )}{{K}_{R} ( t + Δ t ) + 1}} {e}^{j 2 π ( \frac{( {f}_{c} - f ) {d}_{qp} ( t ) - ( {f}_{c} - f - Δ f ) dqp}{c} ( t + Δ t )} ) ]$$

where, c is the speed of light;
R_{qp}^{N}(t, f; Δt, Δf) represents the time-frequency correlation function of the NLOS path, and without considering the correlation between multipaths, is expressed as:

$${R}_{q p}^{N} ( t , f ; Δ t , Δ f ) = {P}_{surv} ( Δ t , Δ f ) \cdot 𝔼 [ {\sum }_{m = 1}^{M} {\sum }_{n = 1}^{N} \sqrt{{P}_{qp , {n}_{m} , {f}_{c}} ( t , f ) {P}_{qp , {n}_{m} , {f}_{c}} ( t + Δ t , f + Δ f )} \cdot {e}^{j 2 π ( \frac{( {f}_{c} - f ) {d}_{qp ,} {n}_{m} ( t ) - ( {f}_{c} - f - Δ f ) {d}_{qp ,} {n}_{m} ( t + Δ t )}{c} )} \vert$$

Step S704: calculating the Doppler frequency of each multipath:

$${v}_{qp , {n}_{m}} ( t ) = - \frac{{v}^{T}}{λ} cos ( {ω}_{p}^{T} ) - \frac{{v}^{R}}{λ} cos ( {ω}_{q}^{R} ) + \frac{{sin}^{2} ( {ω}_{p}^{T} ) {( {v}^{T} )}^{2} t}{λ ( {d}_{{n}_{m}}^{T} - cos ( {ϑ}^{T} ) {δ}_{p} )} + \frac{{sin}^{2} ( {ω}_{q}^{R} ) {( {v}^{R} )}^{2} t}{λ ( {d}_{{n}_{m}}^{R} - cos ( {ϑ}^{R} ) {δ}_{q} )}$$

where δₚ/δ_{q} in the equation represent the antenna spacings at the transmitting end and the receiving end, ωₚ^{T} represents an angle between the moving direction of the transmitting end and the nₘth path corresponding to the pth transmitting antenna, ω_{q}^{R} represents an angle between the moving direction of the receiving end and the nₘth path corresponding to the qth receiving antenna, and ϑ^{T} represents an angle between the transmitting antenna array and the nₘth path corresponding to the 1st transmitting antenna/receiving antenna; and by calculating the Doppler frequencies corresponding to all multipaths in each simulation, local Doppler spread under this simulation can be obtained, and through multiple simulations to obtain the sample mean, local Doppler spread under this type of scenario can be obtained:

$${B}_{q p}^{( 2 )} ( t ) = 𝔼 [ \sqrt{\overline{[ {{v}_{qp , {n}_{m}} ( t )}^{2} ]} - \overline{{[ {v}_{qp , {n}_{m}} ( t ) ]}^{2}}} ] .$$

The satellite communication-oriented geometry-based stochastic channel modeling method of the present invention has the following advantages: The present invention provides a general three-dimensional geometry-based stochastic satellite channel model, which is applicable to the commonly used satellite communication bands ranging from S-band to millimeter-wave band, and, by modeling the satellite mobility based on real orbits, is suitable for the communication scenarios of LEO, MEO and GEO satellites. On the basis of a satellite channel simulation scenario, the present invention sets the scenario layout parameters, initializes the trajectories and speed of the satellite and the receiving end, and supports simultaneous movement of the transmitting and receiving ends and the clusters. It takes into account the spatial consistency of large-scale parameters and the correlation of the channel parameters: environment, frequency and satellite elevation, and considers the effect of rainfall on the large-scale parameters. With respect to large-scale fading, it considers path loss, shadow fading, atmospheric absorption, and rainfall attenuation. The time delay, angle and power of the cluster are calculated by calculating the geometric position information of the cluster and the scatterer, to generate the channel coefficient. The birth and death of the cluster in the time domain and the frequency domain are taken into account, and the statistical characteristics of the channel are derived for simulation analysis. In addition, the model considers the ionospheric effect that is more likely to happen at the low-frequency band and the rainfall attenuation that is more likely to happen at the millimeter-wave band respectively, becoming the first geometry-based stochastic channel model that considers the effect of rainfall attenuation on both the large-scale fading and small-scale fading.

### BRIEF DESCRIPTION OF THE DRAWINGS

FIG. 1 is a schematic flow chart of a satellite communication-oriented geometry-based stochastic channel modeling method according to the embodiment; and

FIG. 2 is a schematic diagram of a three-dimensional general geometry-based stochastic channel model for satellite communication according to the embodiment.

### DETAILED DESCRIPTION OF THE INVENTION

In order to better understand the purpose, structure and function of the present invention, the satellite communication-oriented geometry-based stochastic channel modeling method of the present invention is further described in detail below with reference to the accompanying drawings.

### Embodiment 1

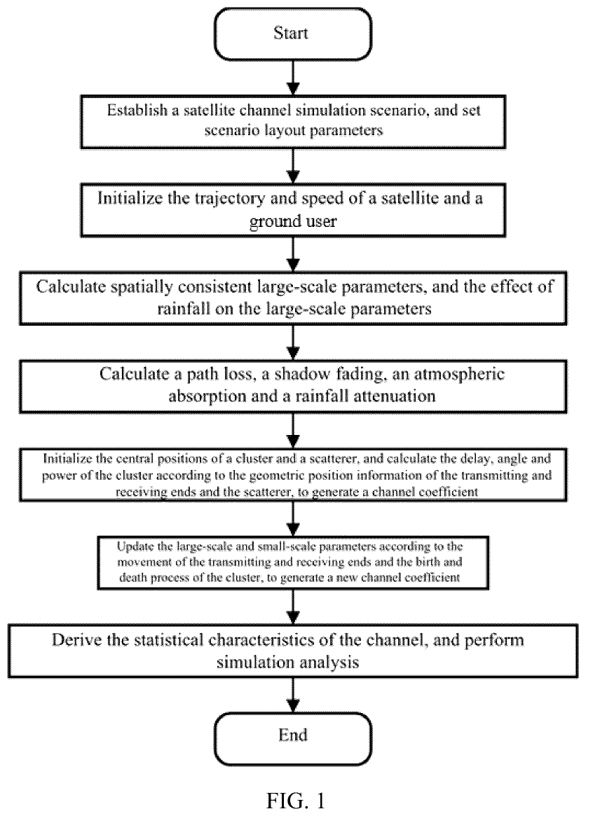

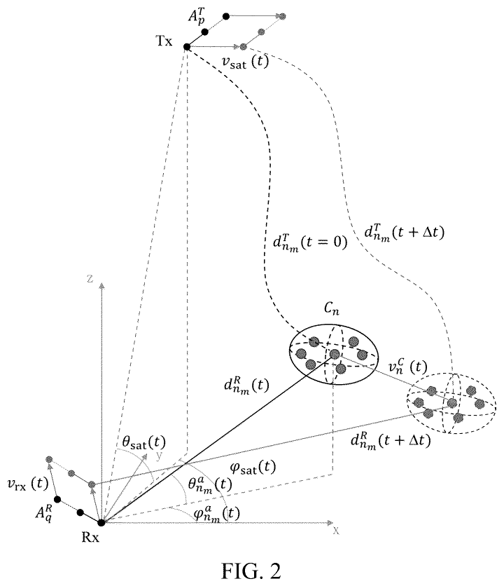

Referring to FIG. 1 and FIG. 2, this embodiment provides a scenario prediction channel modeling method based on scatterer density, specifically including:
Step S1: a satellite channel simulation scenario is established, and the physical environment parameters in the satellite communication channel scenario are set, as shown in FIG. 2.

Specifically, in this embodiment, the step S1 specifically includes:
Step S101: the transmitting end and receiving end of the model are a satellite mobile receiving end and a ground mobile receiving end respectively, the orbital altitude hₛₐₜ of the satellite needs to be pre-set, and the environment of the ground mobile receiving end also needs to be pre-set as a dense city, a city, a suburb, or a rural area;
Step S102: both the transmitting end and receiving end of the model are a multiple-transmit multiple-receive antenna array, so the spacing and angle parameters of the antenna array need to be initialized, where the antenna array is a uniformly distributed linear array. The transmitting end has a total of P antennas, Aₚ^{T} denotes the pth antenna, and β_{A}^{T} and β_{E}^{T} denote an azimuth angle and an elevation angle of the transmitting-end antenna array respectively, a spacing between the antennas is δ^{T}; and the receiving end has a total of Q antennas, A_{q}^{T} denotes the qth antenna, β_{A}^{R} and β_{E}^{R} denote an azimuth angle and an elevation angle of the receiving-end antenna array respectively, and a spacing between the antennas is δ^{R}.
Step S103: the system parameters of the model further include a carrier frequency f_{c}, and a rainfall rate set based on whether it is raining, where, without rain, it is set to 0 mm/h; and with a heavy rain, it is set to 50 mm/h.
Step S2: initializing the trajectory and speed of a satellite and a receiving end;

Specifically, in this embodiment, the step S2 specifically includes:
Step S201: the initial position of the satellite can be determined together by the orbital altitude hₛₐₜ, elevation θₛₐₜ and azimuth φₛₐₜ. Satellites can be divided into GEO satellites and NGEO satellites depending on whether the satellites are stationary relative to the earth. GEO satellites are stationary relative to the ground at an altitude of about 36,000 km. Due to the Earth's gravity, NGEO satellites orbit the Earth along a certain trajectory. First, an elliptical orbital plane of the satellite is determined by setting the following five parameters: a length a of the semi-major axis of the elliptical orbit; an eccentricity e of the elliptical orbit, where, if the eccentricity e is set to 0, the elliptical orbit is reduced to a circular orbit; an angle between the orbit and the equatorial plane is an orbital plane inclination ι; the longitude of the point where the orbit crosses the equatorial plane upward is called a right ascension of the ascending node Ω; the direction of the ellipse on the orbital plane is determined by an argument of perigee ω of an angle between the orbital perigee and the ascending node. A true anomaly υ represents an angle swept by moving along the orbit from the perigee; and after determination of the orbital plane, the specific position of the satellite in the elliptical orbit can be determined via υ; The satellite trajectory is determined together by a time-varying right ascension of the ascending node Ω(t) caused by orbital perturbations and a time-varying argument of perigee ω(t) as well as a change υ(t) in the true anomaly caused by the Earth's gravity, where the three values are calculated by referring to a standardization document QuaDRIGA. At each moment, in the Cartesian coordinate system with the geocenter as the origin, the position of the moving satellite can be expressed as:

$${x}_{s a t} = R ( t ) \cdot \{ cos ( ω ( t ) + v ( t ) ) \cdot cos Ω ( t ) - sin ( ω ( t ) + v ( t ) ) \cdot sin Ω ( t ) \cdot cos ( ι ) \}$$

$${y}_{s a t} = R ( t ) \cdot \{ cos ( ω ( t ) + v ( t ) ) \cdot sin Ω ( t ) - sin ( ω ( t ) + v ( t ) ) \cdot cos Ω ( t ) \cdot cos ( ι ) \}$$

$${z}_{s a t} = R ( t ) \cdot sin ( ω ( t ) + v ( t ) ) \cdot sin ( ι )$$

where, R(t) is a distance from the geocenter to the satellite at each moment, calculated as:

$$R ( t ) = \frac{a \cdot {( 1 - e )}^{2}}{1 + e \cdot cos v ( t )}$$

the in-orbit speed of a satellite in an elliptical orbit is time-varying, given by

$$\sqrt{{μ}_{E} ( \frac{2}{R ( t )} - \frac{1}{a} )}$$

km/s; when the eccentricity e of the elliptical orbit is set to 0, the elliptical orbit is reduced to a circular orbit with a constant speed \sqrt{μ_{E}/a} km/s, where, μ_{E} is a gravitational constant, with a value of 3.986012×10⁵ km³/s².
Step S202: the receiving end is set as a moving vehicle, of which a speed vᵣₓ and a moving trajectory are set.
Step S3: calculating spatially consistent large-scale parameters, and the effect of rainfall on the large-scale parameters;

Specifically, in this embodiment, step S3 specifically includes:
Step S301: in order to generate the large-scale parameters related to frequency, environment and elevation, this model adopts the linear model and satellite scenario parameter table proposed in the standardization document QuaDRIGA and related studies thereof to generate spatially consistent large-scale parameters: large-scale fading PL, shadow fading SH, delay spread DS, azimuth angular spread of arrival ASA, elevation angular spread of arrival ESA, Rician K-factor KF and cross-polarization ratio XPR. For each large-scale parameter that needs to be calculated, the following general formula is employed:

$$V = {V}_{μ} + {V}_{ϵ} \cdot {log}_{10} d + {V}_{γ} \cdot {log}_{10} {f}_{G H z} + {V}_{a} \cdot {log}_{10} {α}_{rad} + X ( {V}_{σ} + {V}_{δ} \cdot {log}_{10} {f}_{G H z} + {V}_{β} \cdot {log}_{10} {α}_{rad} )$$

where, the parameters such as V_{μ} are related to the environment, and X is a spatially consistent normally distributed random variable with a mean of 0 and a variance of 1.

Step S302: a rainfall rate R is considered, where the effect of rainfall on channel multipath fading is reflected in the changes of the parameters KF, DS, ASA and ESA caused by the rainfall rate. The existing GBSM satellite channel model assumes that the tropospheric effect and multipath effect are independent of each other. In fact, rainfall may cause atmospheric inhomogeneity and consequent strong and compact edges of rain cells, which in turn lead to stronger multipath effects. In addition, rain adheres to the surfaces of scatterers such as buildings and trees, causing the scatterers to change the properties such as scattering and reflection of electromagnetic waves. Through actual measurements, it is found that rainfall will increase the number of multipaths, and as the rainfall rate rises, the delay spread and power of the multipaths increase, while the power of the direct path decreases. The Rician K-factor KF decreases as the rainfall rate rises, and the multipath effect of the channel becomes more obvious. This model employs the parameter ξ_{KF} to denote the effect of the rainfall rate on the Rician K-factor, and the Rician K-factor affected by the rainfall can be modeled as:

$$K {F}_{R} = K F - R \cdot {ξ}_{K F}$$

As the rainfall rate increases, the multipath delay spread increases; and due to the presence of compact rain cells and the change in scatterer humidity, new multipaths appear, and it can be inferred that rainfall will cause a certain increase in angular spread. This model assumes that the effect of rainfall on multipath is linear, using the parameters ξ_{DS}, ξ_{ASA} and ξ_{ESA} to measure the effect of rainfall on a cluster; and the specific value needs to be determined through measurement. The effect of the rainfall rate on the delay spread and angular spread is expressed as:

$${DS}_{R} = DS ( 1 + R \cdot {ξ}_{DS} )$$

$${ASA}_{R} = ASA ( 1 + R \cdot {ξ}_{ASA} )$$

$${ESA}_{R} = ESA ( 1 + R \cdot {ξ}_{ESA} )$$

in addition, an increase in the number of multipaths during rainfall may be modeled as an increase in the number of clusters; and the model models the newly added clusters Nᵣₐᵢₙ due to rainfall in a Poisson distribution:

$${N}_{rain} ∼ P ( R \cdot {ξ}_{λ} )$$

Step S4: calculating a path loss, a shadow fading, an atmospheric absorption and a rainfall attenuation;

Specifically, in this embodiment, the step S4 specifically includes:
Step S401: calculating a free path loss PL, and modeling as a log-distance path loss model, where the shadow fading SF follows a log-normal distribution;
Step S402: calculating the atmospheric absorption A_{R}, by referring to the calculation method of approximate estimation for gas attenuation given in the Recommendations ITU-R-P.676, assuming that the receiving-end height is equal to the sea level height, and taking the mean annual global reference atmosphere values as the environmental parameters: temperature T=288.15 K, dry air atmospheric pressure p=1013.25 hPa, water vapor density ρ=7.5 g/m³ and water vapor pressure

$$e = \frac{ρ T}{216.5} = 9.98 hPa .$$

A_{G} may be expressed as:

$${A}_{G} = \frac{{A}_{zenith} ( f )}{sin ( θ )}$$

where, θ is the satellite elevation, and A_{zenith}(f) is the zenith angle attenuation, depending on the environmental parameters and carrier frequency; and
Step S403: calculating the large-scale fading caused by rainfall at a specific rainfall rate, and calculating a rainfall attenuation coefficient with reference to the Crane model, the rainfall attenuation expressed as:

$${A}_{R} = {a}_{Crane} {R}^{{b}_{Crane}} \cdot \frac{{h}_{R}}{sin {θ}_{sat}}$$

where, h_{R} denotes the rainfall height, θₛₐₜ denotes the satellite elevation, the parameters a_{Crane} and b_{Crane} are Crane model parameters which are obtained from discrete calculations and can be derived by curve fitting to a power law coefficient; and a relationship between the rainfall height h_{R} and the zero-degree isotherm h₀ is given by:

$${h}_{R} = {h}_{0} + 0.36$$

where, the unit thereof is km, and h₀ is related to the longitude and latitude of the earth. where, the parameters a_{Crane} and b_{Crane} are calculated as:

$${log}_{10} {a}_{Crane} = {\sum }_{j = 1}^{4} ( {α}_{j} exp [ - {( \frac{{log}_{10} {f}_{c} - {β}_{j}}{{γ}_{j}} )}^{2} ] ) + {m}_{k} {log}_{10} {f}_{c} + {c}_{k} \\ {b}_{Crane} = {\sum }_{j = 1}^{5} ( {α}_{j} exp [ - {( \frac{{log}_{10} {f}_{c} - {β}_{j}}{{γ}_{j}} )}^{2} ] + {m}_{α} {log}_{10} {f}_{c} + {c}_{α}$$

where, the values of the parameters α, β, γ, m are obtained by referring to Table 1-4 in Recommendations ITU-R P.838-3. Note: h_{R} is not the true altitude of the satellite because rainfall is only distributed within a certain altitude in the troposphere, referring to the relationship between the rainfall height h_{R} and the zero-degree isotherm h₀ given in Recommendations ITU-R P.839-4:

$${h}_{R} = {h}_{0} + 0.36$$

the unit thereof is km, and h₀ is related to the longitude and latitude of the earth. Since this model does not consider the spatial statistical characteristics of the Earth's scale, so take the mean value to be 3 km. If necessary, accurate h₀ may also be obtained according to the digital map given in the above standardization documents.
Step S5: initializing the central positions of a cluster and a scatterer, and calculating the delay, angle and power of the cluster according to the geometric position information of the transmitting and receiving ends and the scatterer, to generate a channel coefficient;

Specifically, in this embodiment, the step S5 specifically includes:
Step S501: calculating a delay τₙ of each cluster, a receiving-end azimuth angle φₙ^{a} and a receiving-end elevation angle θₙ^{a} using the large-scale parameters calculated in Step S301, wherein the delay of the cluster follows a unilateral exponential distribution, and an initial value thereof is calculated as:

$${\tilde{τ}}_{l} = - ln \{ {X}_{l}^{τ} ( {x}_{t} , {y}_{t} , {z}_{t} , {x}_{r} , {y}_{r} , {z}_{r} ) \}$$

and may be scaled by the large-scale parameters as:

$${τ}_{l} = {\tilde{τ}}_{l} \cdot \frac{1}{F} \cdot {\sum }_{f = 1}^{F} \frac{D {S}_{f}}{}$$

the initial value of angle \tilde{ϕ}ₗ follows a uniform distribution and may be scaled by a large-scale parameter:

$${ϕ}_{l} = arg exp \{ j \cdot {\tilde{ϕ}}_{l} \cdot s \} , s = \frac{1}{F} \cdot {\sum }_{f = 1}^{F} \frac{A {S}_{f}}{} , s < \{ \begin{matrix}3. , & azimuth angle \\ 1.5 , & elevation angle\end{matrix}$$

Step S502: calculating the polar coordinates of each cluster with the receiving end as the origin via a geometrical relationship, according to the basic information of the cluster generated in Step S501:

$${( {d}_{n}^{T} )}^{2} = {( {d}_{n}^{R} )}^{2} + {d}^{2} - 2 \cdot {d}_{n}^{R} \cdot d \cdot cos {α}_{n}$$

where, dₙ^{T} is the distance from the nth cluster to the transmitting end at the initial moment, dₙ^{R} is the distance from the nth cluster to the receiving end, and d is the distance between the transmitting end and the receiving end. The angle αₙ is the angle between a unit vector of the receiving end pointing to the nth cluster and a unit vector of the receiving end pointing to the transmitting end; with the given three-dimensional angular information φₙ^{a}, θₙ^{a}, φₛₐₜ, θₛₐₜ of the nth scatterer and the transmitting end of satellite, the angle αₙ may be calculated by the following equation:

$$\{ \begin{matrix}{\hat{x}}_{n} = cos {θ}_{n}^{a} cos {φ}_{n}^{a} \\ {\hat{y}}_{n} = cos {θ}_{n}^{a} sin {φ}_{n}^{a} \\ {\hat{z}}_{n} = sin {θ}_{n}^{a}\end{matrix} , \\ \{ \begin{matrix}{\hat{x}}_{sat} = cos {θ}_{sat} cos {φ}_{sat} \\ {\hat{y}}_{sat} = cos {θ}_{sat} sin {φ}_{sat} \\ {\hat{z}}_{sat} = sin {θ}_{sat}\end{matrix} , cos {α}_{n} = \frac{{\hat{x}}_{n} {\hat{x}}_{sat} + {\hat{y}}_{n} {\hat{y}}_{sat} + {\hat{z}}_{n} {\hat{z}}_{sat}}{\vert ( {\hat{x}}_{n} , {\hat{y}}_{n} , {\hat{z}}_{n} ) \vert \vert ( {\hat{x}}_{sat} , {\hat{y}}_{sat} , {\hat{z}}_{sat} ) \vert}$$

next, the central position (dₙ^{R}, φₙ^{a}, θₙ^{a}) of the cluster in the polar coordinates with the receiving end as the origin may be obtained;
Step S503: calculating the geometric positions of the scatterers in each cluster, where the scatterers in the model are in a three-dimensional elliptical Gaussian distribution around the center of the cluster; the three dimensions of the scatterer follow a Gaussian distribution with a standard deviation of σₓ, σ_{y}, σ_{z}, and in the three-dimensional Cartesian coordinate system with the receiving end as the origin, the coordinates (xₙ_{ₘ}, yₙ_{ₘ}, zₙ_{ₘ}) of each scatterer may be calculated by the following equation:

$$[ \begin{matrix}{x}_{{n}_{m}} \\ {y}_{{n}_{m}} \\ {z}_{{n}_{m}}\end{matrix} ] = [ \begin{matrix}cos ( {φ}_{n} ) & - sin ( {φ}_{n} ) & 0 \\ sin ( {φ}_{n} ) & cos ( {φ}_{n} ) & 0 \\ 0 & 0 & 1\end{matrix} ] \cdot [ \begin{matrix}cos ( {θ}_{n} ) & 0 & - sin ( {θ}_{n} ) \\ 0 & 1 & 0 \\ sin ( {θ}_{n} ) & 0 & cos ( {θ}_{n} )\end{matrix} ] \cdot [ \begin{matrix}{x}^{′} + {d}_{n}^{R} \\ {y}^{′} \\ {z}^{′}\end{matrix} ] \\ p ( {x}^{′} , {y}^{′} , {z}^{′} ) = \frac{exp ( - \frac{{x}^{′2}}{2 {σ}_{x}^{2}} - \frac{{y}^{′2}}{2 {σ}_{y}^{2}} - \frac{{z}^{′2}}{2 {σ}_{z}^{2}} )}{{( 2 π )}^{3 / 2} {σ}_{x} {σ}_{y} {σ}_{z}}$$

Step S504: calculating the path length d_{qp,n}_{ₘ}(t), delay τ_{qp,n}_{ₘ}(t) and power of each path according to the geometric positions of the scatterers determined in Step S503, wherein the model needs to consider the delay resolution of subpaths, which, with the changes of power in the time domain and frequency domain taken into account, may be calculated as:

$${P}_{qp , {n}_{m} , {f}_{c}} ( t , f ) = exp ( - {τ}_{qp , {n}_{m}}^{′} ( t ) {g}_{{f}_{c}}^{DS} ) 1 {0}^{- \frac{{Z}_{n}}{10}} {( \frac{f}{{f}_{c}} )}^{γ}$$

where, τ_{qp,n}_{ₘ}′(t) is a relative delay of each subpath, Zₙ is a cluster shadow calculated for each cluster, which follows a Gaussian distribution with a mean of 0;

$${( \frac{f}{{f}_{c}} )}^{γ}$$

models the frequency-dependent characteristic of power in a millimeter-wave high-bandwidth channel, and γ is related to frequency; g_{F}_{_{c}}^{DS} is a delay spread scale factor, which is, with different calculation methods employed in single-frequency point modeling and multi-frequency point modeling, expressed as:

$${g}_{{f}_{c}}^{DS} = \{ \begin{matrix}- 1.5 \cdot ln \{ 1.2 \cdot \frac{{DS}_{{f}_{c}}}{max ( {DS}_{{f}_{c}} ) + min ( {DS}_{{f}_{c}} )} - 0.15 \} , multiple frequency points \\ \frac{{r}_{τ} - 1}{{r}_{τ} DS} , single frequency point\end{matrix}$$

where, DS is the delay spread, and r_{τ} is a delay distribution scale factor; and
Step S505: calculating the channel coefficient according to the generated parameters:

$$H = {[ PL \cdot SH \cdot {A}_{G} \cdot {A}_{R} ]}^{1 / 2} \cdot {h}_{qp , {f}_{c}} ( t , τ )$$

where, the large-scale fading [PL·SH·A_{G}·A_{R}]^{1/2} is calculated in Step 4, and the small-scale fading h_{qp,f}_{_{c}}(t, τ) is expressed as:

$${h}_{qp , {f}_{c}} ( t , τ ) = \sqrt{\frac{{K}_{R} ( t )}{{K}_{R} ( t ) + 1} {h}_{qp , {f}_{c}}^{L} ( t , τ )} + \sqrt{\frac{1}{{K}_{R} ( t )} {h}_{qp , {f}_{c}}^{N} ( t , τ )}$$

where, K_{R}(t) is the Rician K-factor that varies with time, and h_{qp,f}_{_{c}}^{L}(t, τ) and h_{qp,f}_{_{c}}^{N}(t, τ) are the channel impulse response of a LOS path and a NLOS path respectively, expressed as:

$$\begin{matrix}{h}_{qp , {f}_{c}}^{L} ( t , τ ) = {[ \begin{matrix}{F}_{q , V} ( {ϕ}_{E , L}^{R} ( t ) , {ϕ}_{A , L}^{R} ( t ) ) \\ {F}_{q , H} ( {ϕ}_{E , L}^{R} ( t ) , {ϕ}_{A , L}^{R} ( t ) )\end{matrix} ]}^{T} \cdot [ \begin{matrix}{e}^{j {θ}_{L}^{VV}} & 0 \\ 0 & - {e}^{j {θ}_{L}^{HH}}\end{matrix} ] \cdot {F}_{r} \cdot [ \begin{matrix}{F}_{p , V} ( {ϕ}_{E , L}^{T} ( t ) , {ϕ}_{A , L}^{T} ( t ) ) \\ {F}_{p , H} ( {ϕ}_{E , L}^{T} ( t ) , {ϕ}_{A , L}^{T} ( t ) )\end{matrix} ] \cdot {e}^{j 2 π {f}_{c} {τ}_{qp}^{L} ( t )} δ ( τ - {τ}_{qp}^{L} ( t ) ) \\ {h}_{qp , {f}_{c}}^{N} ( t , τ ) = {\sum }_{n = 1}^{{N}_{qp} ( t )} {\sum }_{m = 1}^{{M}_{n} ( t )} {[ \begin{matrix}{F}_{q , {f}_{c} , , V} ( {ϕ}_{E , {n}_{m}}^{R} ( t ) , {ϕ}_{A , {n}_{m}}^{R} ( t ) ) \\ {F}_{q , {f}_{c} , H} ( {ϕ}_{E , {n}_{m}}^{R} ( t ) , {ϕ}_{A , {n}_{m}}^{R} ( t ) )\end{matrix} ]}^{T} \cdot [ \begin{matrix}{e}^{j {θ}_{{n}_{m}}^{VV}} & \sqrt{μ {κ}_{{n}_{m}}^{- 1} ( t )} {e}^{j {θ}_{{n}_{m}}^{VH}} \\ \sqrt{{κ}_{{n}_{m}}^{- 1} ( t )} {e}^{j {θ}_{{n}_{m}}^{HV}} & \sqrt{μ} {e}^{j {θ}_{{n}_{m}}^{HH}}\end{matrix} ] \cdot {F}_{r} \cdot [ \begin{matrix}{F}_{p , {f}_{c} , , V} ( {ϕ}_{E , {n}_{m}}^{T} ( t ) , {ϕ}_{A , {n}_{m}}^{T} ( t ) ) \\ {F}_{p , {f}_{c} , H} ( {ϕ}_{E , {n}_{m}}^{T} ( t ) , {ϕ}_{A , {n}_{m}}^{T} ( t ) )\end{matrix} ] \cdot \sqrt{{P}_{qp , {n}_{m} , {f}_{c}} ( t )} \cdot {e}^{j 2 π {f}_{c} {τ}_{qp} , {n}_{m} ( t )} δ ( τ - {τ}_{qp , {n}_{m}} ( t ) )\end{matrix}$$

where, [.]^{T} denotes transpose, F_{p(q),f}_{_{c}}_{V} is a vertical polarization antenna pattern of the transmitting and receiving antennas, and F_{p(q),f}_{_{c}}_{H} is an horizontal polarization antenna pattern; κₙ_{ₘ} (t) is a cross-polarization ratio, u denotes co-polarization imbalance, ϕ_{A,L}^{T}(t) is an azimuth angle of departure corresponding to the LOS path at the moment t stretching from A₁^{T} to A₁^{R}, ϕ_{E,L}^{T}(t) is an elevation angle of departure corresponding to the LOS path at the moment t stretching from A₁^{T} to A₁^{R}, ϕ_{A,L}^{R}(t) is an azimuth angle of arrival corresponding to the LoS path at the moment t stretching from A₁^{T} to A₁^{R}; ϕ_{E,L}^{R}(t) is an elevation angle of arrival corresponding to the LoS path at the moment t stretching from A₁^{T} to A₁^{R}, θ_{L}^{VV} and θ_{L}^{HH} represent the initial phases of the LOS path, θₙ_{ₘ}^{HH}, θₙ_{ₘ}^{HV}, θₙ_{ₘ}^{VV}, and θₙ_{ₘ}^{VH} represent the initial phases of the NLOS path, which are random variables that follow a uniform distribution between 0 and 2π; Faraday rotation matrix Fᵣ refers to the rotation of a polarization plane caused by the propagation of electromagnetic waves through the ionosphere in the satellite scenario, which needs to be considered in communication scenarios below 10 GHZ; P_{qp,n}_{ₘ}_{,f}_{_{c}}(t) is the subpath power calculated in Step S504, τ_{qp}^{L}(t) is the absolute delay of the Mth of LOS subpath of LOS, which can be calculated by dividing the distance between the transmitting and receiving antennas q,p by the speed of light, and τ_{qp,n}_{ₘ}(t) is the absolute delay of the Mth subpath in the Nth cluster, which can be calculated by dividing the length of the nₘth subpath between the transmitting and receiving antennas q, p by the speed of light.

Step S6: updating the large-scale and small-scale parameters according to the movement of the transmitting and receiving ends and the birth-death process of the cluster, to generate a new channel coefficient; and

Specifically, in this embodiment, the step S6 specifically includes:
Step S601: introducing a survival probability Pₛᵤᵣᵥ(Δt, Δf) of the cluster in the time-frequency domain, with the birth and death of the cluster in the time domain and frequency domain taken into account:

$${P}_{surv} ( Δ t , Δ f ) = {P}_{surv} ( Δ t ) \cdot {P}_{surv} ( Δ f ) = {e}^{- {λ}_{R} \frac{{v}_{rx} Δ t}{{D}_{c}^{T}}} \cdot {e}^{- {λ}_{R} \frac{Δ f}{{D}_{c}^{F}}}$$

where, Pₛᵤᵣᵥ(Δt) is the time-domain cluster survival probability, Pₛᵤᵣᵥ(Δf) is the frequency-domain cluster survival probability, Δt is a time interval, Δf is a frequency interval, the birth-death process of the cluster is described jointly by a generation rate λ_{G} and a disappearance rate λ_{R} of the cluster, these two parameters are related to the environmental characteristics of the communication scenario and the antenna pattern; parameters D_{c}^{T}, D_{c}^{F} are scenario-related factors in the time domain and frequency domain, obtained by channel measurement in a specific scenario; and an expected number [symbol] {N_{new}} of new clusters is calculated as; and

$$𝔼 \{ {N}_{new} \} = \frac{{λ}_{G}}{{λ}_{R}} [ 1 - {P}_{surv} ( Δ t , Δ f ) ]$$

Step S602: updating the channel coefficient according to the step S5, with the movement of the transmitting and receiving ends and the clusters as well as the birth and death of the clusters taken into account.

Step S7: the statistical characteristics of the channel are derived, and simulation analysis is performed;

Specifically, in this embodiment, the step S7 specifically includes:
Step S701: calculating an effective path loss, which consists of three parts: free path loss PL, atmospheric absorption A_{G} and rainfall attenuation A_{R}, wherein the three large-scale fading components do not change rapidly with time, showing a relatively constant trend, and the sum of the three is defined as the effective path loss: PL_{eff}=PL+A_{G}+A_{R}
Step S702: calculating the root-mean-square (RMS) delay spread of the channel, expressed as:

$${D}_{qp , rms} ( t ) = \sqrt{\frac{{\int }_{- ∞}^{∞} {( τ - {μ}_{qp , τ} ( t ) )}^{2} {P}_{qp , {n}_{m} , {f}_{c}} ( t , τ ) d τ}{{\int }_{- ∞}^{∞} {P}_{qp , {n}_{m} , {f}_{c}} ( t , τ ) d τ}}$$

where, τ is the delay, and the average delay can be expressed

$${μ}_{qp , τ} ( t ) = \frac{{\int }_{- ∞}^{∞} τ \cdot {P}_{qp , {n}_{m} , {f}_{c}} ( t , τ ) d τ}{{\int }_{- ∞}^{∞} {P}_{qp , {n}_{m} , {f}_{c}} ( t , τ ) d τ} ;$$

Step S703: calculating a time-frequency correlation function of the channel, with a theoretical value expressed as:

$${R}_{qp} ( t , f ; Δ t , Δ f ) = 𝔼 [ {H}_{qp} ( t , f ) {H}_{q p}^{*} ( t + Δ t , f + Δ f ) ]$$

where, [symbol] [·] represents expectation, [·]* represents the conjugate of a complex number, H_{qp} represents a channel transfer function, which is obtained by Fourier transform of the channel impulse response; without considering the correlation between the LOS path and the NLOS path, the time-frequency correlation function is expressed as the sum of the time-frequency correlation functions of the paths:

$${R}_{qp} ( t , f ; Δ t , Δ f ) = {R}_{q p}^{L} ( t , f ; Δ t , Δ f ) + {R}_{q p}^{N} ( t , f ; Δ t , Δ f )$$

where, R_{qp}^{L}(t, f; Δt, Δf) represents the time-frequency correlation function of the LOS path, expressed as:

$${R}_{q p}^{L} ( t , f ; Δ t , Δ f ) = 𝔼 [ \sqrt{\frac{{K}_{R} ( t )}{{K}_{R} ( t ) + 1} \cdot \frac{{K}_{R} ( t + Δ t )}{{K}_{R} ( t + Δ t ) + 1} {e}^{j 2 π ( \frac{( {f}_{c} - f ) {d}_{qp} ( t ) - ( {f}_{c} - f - Δ f ) dqp}{c} ( t + Δ t ) )}} ]$$

where, c is the speed of light;
R_{qp}^{N}(t, f; Δt, Δf) represents the time-frequency correlation function of the NLOS path, and without considering the correlation between multipaths, is expressed as:

$${R}_{q p}^{N} ( t , f ; Δ t , Δ f ) = {P}_{surv} ( Δ t , Δ f ) \cdot 𝔼 [ {\sum }_{m = 1}^{M} {\sum }_{n = 1}^{N} \sqrt{{P}_{qp , {n}_{m ,} {f}_{c}} ( t + Δ t , f + Δ f )} \cdot {e}^{j 2 π ( \frac{( {f}_{c} - f ) {d}_{qp} , {n}_{m} ( t ) - ( {f}_{c} - f - Δ f ) {d}_{qp} , {n}_{m} ( t + Δ t )}{c} )} ]$$

Step S704: calculating the Doppler frequency of each multipath:

$$\begin{matrix}{v}_{qp , {n}_{m} ( t )} = - \frac{{v}^{T}}{λ} cos ( {ω}_{p}^{T} ) - \frac{{v}^{R}}{λ} cos ( {ω}_{q}^{R} ) \\ + \frac{{sin}^{2} ( {ω}_{p}^{T} ) {( {v}^{T} )}^{2} t}{λ ( {d}_{{n}_{m}}^{T} - cos ( {ϑ}^{T} ) {δ}_{p} )} + \frac{{sin}^{2} ( {ω}_{p}^{R} ) {( {v}^{R} )}^{2} t}{λ ( {d}_{{n}_{m}}^{R} - cos ( {ϑ}^{R} ) {δ}_{q} )}\end{matrix}$$

where, δₚ/δ_{q} in the equation represent the antenna spacings at the transmitting end and the receiving end, ωₚ^{T} represents an angle between the moving direction of the transmitting end and the nₘth path corresponding to the pth transmitting antenna, ω_{q}^{R} represents an angle between the moving direction of the receiving end and the nₘth path corresponding to the qth receiving antenna, and ϑ^{T} represents an angle between the transmitting antenna array and the nₘth path corresponding to the 1st transmitting antenna/receiving antenna; and by calculating the Doppler frequencies corresponding to all multipaths in each simulation, local Doppler spread under this simulation can be obtained, and through multiple simulations to obtain the sample mean, local Doppler spread under this type of scenario can be obtained:

$${B}_{q p}^{( 2 )} ( t ) = 𝔼 [ \sqrt{\overline{[ {{v}_{qp , {n}_{m}} ( t )}^{2} ]} - \overline{{[ {v}_{qp , {n}_{m}} ( t ) ]}^{2}}} ]$$

To sum up, the present invention provides a general three-dimensional geometry-based stochastic satellite channel model, which is applicable to the commonly used satellite communication bands ranging from S-band to millimeter-wave band, and, by modeling the satellite mobility based on real orbits, is suitable for the communication scenarios of LEO, MEO and GEO satellites. The model takes into account the spatial consistency of large-scale parameters and the correlation of the channel parameters: environment, frequency and satellite elevation, and supports simultaneous movement of the transmitting and receiving ends and the clusters; and it considers the birth and death of the clusters in the time domain and frequency domain, and supports the delay resolution of subpaths. In addition, the model models the ionospheric effect that is more likely to happen at the low-frequency band and the rainfall attenuation that is more likely to happen at the millimeter-wave band respectively. The present invention may be used to simulate the statistical characteristics of the channel, including effective path loss, RMS delay spread, time-frequency correlation function and local Doppler spread, and can be applied to the analysis of the effect of rain, satellite trajectory, carrier frequency and receiving-end environment on the channel, laying a foundation for the research on channel analysis, system design, etc.

It may be understood that the present invention is described with some embodiments, and those skilled in the art will appreciate that various changes or equivalent substitutions may be made to these features and embodiments without departing from the spirit and scope of the present invention. In addition, under the teaching of the present invention, these features and embodiments may be modified to adapt to a particular situation and material, without departing from the spirit and scope of the present invention. Therefore, the present invention is not limited to the specific embodiments disclosed herein, and all embodiments falling within the scope of the claims of this application belong to the scope of protection of the present invention.

What is claimed is:

1. A satellite communication-oriented geometry-based stochastic channel modeling method, wherein the channel modeling method comprises the following steps:
Step S1: establishing a satellite communication-oriented geometry-based stochastic channel model and a satellite channel simulation scenario corresponding to the model, and setting scenario layout parameters;
Step S2: initializing the trajectory and speed of a satellite and a receiving end;
Step S3: calculating spatially consistent large-scale parameters, and the effect of rainfall on the large-scale parameters;
Step S4: calculating a path loss, a shadow fading, an atmospheric absorption and a rainfall attenuation;
Step S5: initializing the central positions of a cluster and a scatterer, and calculating the delay, angle and power of the cluster according to the geometric position information of the transmitting and receiving ends and the scatterer, to generate a channel coefficient;
Step S6: updating the large-scale and small-scale parameters according to the movement of the transmitting and receiving ends and the birth-death process of the cluster, to generate a new channel coefficient; and
Step S7: deriving the statistical characteristics of the channel, and performing simulation analysis.

2. The satellite communication-oriented geometry-based stochastic channel modeling method according to claim 1, wherein the step S1 specifically comprises the following steps:
Step S101: the transmitting end of the model is a satellite mobile receiving end, the receiving end is a ground mobile receiving end, the orbital altitude hₛₐₜ of the satellite needs to be pre-set according to the requirements of the simulation environment, and the environment of the ground mobile receiving end also needs to be pre-set as a dense city, a city, a suburb, or a rural environment;
Step S102: both the transmitting end and the receiving end of the model are a multiple-transmit multiple-receive antenna array, so the spacing and angle parameters of the antenna array need to be initialized, wherein the antenna array is a uniformly distributed linear array; the transmitting end has a total of P antennas, Aₚ^{T}, denotes the pth antenna, β_{A}^{T} denotes an azimuth angle of the transmitting-end antenna array, β_{E}^{T} denotes an elevation angle of the transmitting-end antenna array, and a spacing between the antennas is δ^{T}; and the receiving end has a total of Q antennas, A_{q}^{T} denotes the qth antenna, β_{A}^{R} denotes an azimuth angle of the receiving-end antenna array, β_{E}^{R} denotes an elevation angle of the receiving-end antenna array, and a spacing between the antennas is δ^{R}; and
Step S103: the system parameters of the model further comprise a carrier frequency f_{c}, and a rainfall rate set based on whether it is raining.

3. The satellite communication-oriented geometry-based stochastic channel modeling method according to claim 2, wherein the step S2 specifically comprises:
Step S201: the initial position of the satellite is determined together by the orbital altitude hₛₐₜ, elevation θₛₐₜ and azimuth φₛₐₜ; satellites are divided into GEO satellites and NGEO satellites according to whether the satellites are stationary relative to the earth; the GEO satellites are stationary relative to the ground; under the Earth's gravity, the NGEO satellites orbit the earth in an elliptical trajectory; first, an elliptical orbital plane of the satellite is determined by setting the following five parameters: a length a of the semi-major axis of the elliptical orbit; an eccentricity e of the elliptical orbit, wherein if the eccentricity e is set to 0, the elliptical orbit is reduced to a circular orbit; the angle between the orbit and the equatorial plane is an orbital plane inclination ι; the longitude of the point where the orbit crosses the equatorial plane upward is called a right ascension of the ascending node Ω; the direction of the ellipse on the orbital plane is determined by an argument of perigee ω of an angle between the orbital perigee and the ascending node; a true Anomaly υ represents an angle swept by moving along the orbit from the perigee; after determination of the orbital plane, the specific position of the satellite in the elliptical orbit can be determined via υ; the satellite trajectory is determined together by a time-varying right ascension of the ascending node Ω(t) caused by orbital perturbations and a time-varying argument of perigee ω (t) as well as a change υ(t) in the true anomaly caused by the Earth's gravity; at each moment, in the Cartesian coordinate system with the geocenter as the origin, the position coordinates (xₛₐₜyₛₐₜ, zₛₐₜ) of the moving satellite are expressed as:
$$\begin{matrix}{x}_{sat} = R ( t ) \cdot \{ cos ( ω ( t ) + v ( t ) ) \cdot cos Ω ( t ) - sin ( ω ( t ) + v ( t ) ) \cdot sin Ω ( t ) \cdot cos ( l ) \} \\ {y}_{sat} = R ( t ) \cdot \{ cos ( ω ( t ) + v ( t ) ) \cdot sin Ω ( t ) - sin ( ω ( t ) + v ( t ) ) \cdot cos Ω ( t ) \cdot cos ( l ) \} \\ {z}_{sat} = R ( t ) \cdot sin ( ω ( t ) + v ( t ) ) \cdot sin ( l )\end{matrix}$$
where, R(t) is a distance from the geocenter to the satellite at each moment, calculated as:
$$R ( t ) = \frac{a \cdot {( 1 - e )}^{2}}{1 + e \cdot cos v ( t )}$$
the in-orbit speed of a satellite in an elliptical orbit is time-varying, given by
$$\sqrt{{μ}_{E} ( \frac{2}{R ( t )} - \frac{1}{a} )}$$
km/s; when the eccentricity e of the elliptical orbit is set to 0, the elliptical orbit is reduced to a circular orbit with a constant speed \sqrt{μ_{E}/a} km/s, where, μ_{E} is a gravitational constant, with a value of 3.986012×10⁵ km³/s²; and
Step S202: the receiving end is set as a moving vehicle, of which a speed vᵣₓ and a moving trajectory are set.

4. The satellite communication-oriented geometry-based stochastic channel modeling method according to claim 3, wherein the step S3 specifically comprises the following steps:
Step S301: generating spatially consistent large-scale parameters according to the frequency, environment and satellite elevation: large-scale fading PL, shadow fading SH, delay spread DS, azimuth angular spread of arrival ASA, elevation angular spread of arrival ESA, Rician K-factor KF, and cross-polarization ratio XPR, wherein for each large-scale parameter to be calculated, the following general formula is employed:
$$V = {V}_{μ} + {V}_{ϵ} \cdot {log}_{10} d + {V}_{γ} \cdot {log}_{10} {f}_{GHz} + {V}_{α} \cdot {log}_{10} {α}_{rad} + X ( {V}_{σ} + {V}_{δ} \cdot {log}_{10} {f}_{GHz} + {V}_{β} \cdot {log}_{10} {α}_{rad} )$$
where, the parameters V_{μ}, V_{∈}, V_{γ}, V_{α}, V_{σ}, V_{δ} and V_{β} are related to the environment, d is a distance between the transmitting end and the receiving end, f_{GHz} is a carrier frequency, α_{rad} is a satellite elevation, and X is a spatially consistent normally distributed random variable with a mean of 0 and a variance of 1; and
Step S302: setting a rainfall rate to R, wherein the effect of rainfall on channel multipath fading is reflected in the changes of the parameters KF, DS, ASA and ESA caused by the rainfall rate; the model employs the parameter ξ_{KF} to denote the effect of the rainfall rate on the Rician K-factor, and the Rician K-factor KF_{R} affected by the rainfall is expressed as:
$${KF}_{R} = KF - R \cdot {ξ}_{KF}$$
the model assumes that the effect of rainfall on multipath is linear, using the parameters ξ_{DS}, ξ_{ASA} and ξ_{ESA} to measure the effect of rainfall on a cluster; the delay spread DS_{R} and angular spread ASA_{R} and ESA_{R} affected by rainfall are expressed as:
$${DS}_{R} = DS ( 1 + R \cdot {ξ}_{DS} )$$
$${ASA}_{R} = ASA ( 1 + R \cdot {ξ}_{ASA} )$$
$${ESA}_{R} = ESA ( 1 + R \cdot {ξ}_{ESA} )$$
in addition, an increase in the number of multipaths during rainfall is modeled as an increase in the number of clusters; and the model models the newly added clusters Nᵣₐᵢₙ due to rainfall in a Poisson distribution:
$${N}_{rain} ∼ P ( R \cdot {ξ}_{λ} )$$
where, P represents a Poisson distribution, and ξ_{λ} represents an expectation of the distribution.

5. The satellite communication-oriented geometry-based stochastic channel modeling method according to claim 4, wherein the step S4 specifically comprises the following steps:
Step S401: calculating a free path loss PL, and modeling as a log-distance path loss model, wherein the shadow fading SF follows a log-normal distribution;
Step S402: calculating the atmospheric absorption A_{R}, setting the receiving-end height equal to the sea level height, and taking the mean annual global reference atmosphere values as the environmental parameters: temperature T, dry air atmospheric pressure p, water vapor density ρ and water vapor pressure e, wherein A_{G} is expressed as:
$${A}_{G} = \frac{{A}_{z enith} ( f )}{sin ( θ )}$$
where, θ is the satellite elevation, and A_{zenith}(f) is the zenith angle attenuation; and
Step S403: calculating the large-scale fading caused by rainfall at a specific rainfall rate, and calculating a rainfall attenuation coefficient with reference to the Crane model, the rainfall attenuation expressed as:
$${A}_{R} = {a}_{Crane} {R}^{{b}_{Crane}} \cdot \frac{{h}_{R}}{sin {θ}_{s a t}}$$
where, h_{R} denotes the rainfall height, θₛₐₜ denotes the satellite elevation, the parameters a_{Crane} and b_{Crane} are Crane model parameters which are obtained from discrete calculations and can be derived by curve fitting to a power law coefficient; and a relationship between the rainfall height h_{R} and the zero-degree isotherm h₀ is given by:
$${h}_{R} = {h}_{0} + 0.36$$
where, the unit thereof is km, and h₀ is related to the longitude and latitude of the earth.

6. The satellite communication-oriented geometry-based stochastic channel modeling method according to claim 5, wherein the step S5 specifically comprises:
Step S501: calculating a delay τₙ of each cluster, a receiving-end azimuth angle φₙ^{a} and a receiving-end elevation angle θₙ^{a} using the large-scale parameters calculated in Step S301, wherein the delay of the cluster follows a unilateral exponential distribution, and an initial value thereof is calculated as:
$${\tilde{τ}}_{l} = - ln \{ {X}_{l}^{τ} ( {x}_{t} , {y}_{t} , {z}_{t} , {x}_{r} , {y}_{r} , {z}_{r} ) \}$$
where, (xₜ, yₜ, zₜ) denotes the transmitting-end coordinates, and (xᵣ, yᵣ, zᵣ) denotes the receiving-end coordinates;
and scaled by the large-scale parameters as:
$${τ}_{l} = {\tilde{τ}}_{l} \cdot \frac{1}{F} \cdot {\sum }_{f = 1}^{F} \frac{{DS}_{f}}{}$$
where, f=1 . . . F denotes F carrier frequencies, [symbol] _{f} is an initial delay spread, and DS_{f} is a large-scale parameter;
the initial value of angle \tilde{ϕ}ₗ follows a uniform distribution and is scaled by a large-scale parameter:
$${ϕ}_{l} = arg exp \{ j \cdot {\tilde{ϕ}}_{l} \cdot s \} , s = \frac{1}{F} \cdot {\sum }_{f = I}^{F} \frac{{AS}_{f}}{} , s < \{ \begin{matrix}3. , & azimuth angle \\ 1.5 , & elevation angle\end{matrix}$$
where, [symbol] _{f} is an initial delay spread, AS_{f} is the large-scale parameter, and s is a scale;
Step S502: calculating the polar coordinates of each cluster with the receiving end as the origin via a geometrical relationship, according to the basic information of the cluster generated in Step S501:
$${( {d}_{n}^{T} )}^{2} = {( {d}_{n}^{R} )}^{2} + {d}^{2} - 2 \cdot {d}_{n}^{R} \cdot d \cdot cos {α}_{n}$$
where, dₙ^{T} is the distance from the nth cluster to the transmitting end at the initial moment, dₙ^{R} is the distance from the nth cluster to the receiving end, and d is the distance between the transmitting end and the receiving end; the angle αₙ is the angle between a unit vector of the receiving end pointing to the nth cluster and a unit vector of the receiving end pointing to the transmitting end; with the given elevation angle φₙ^{a} and θₙ^{a} of the n th scatterer and the three-dimensional angular information φₛₐₜ and θₛₐₜ of the transmitting end of the satellite, a unit vector (\hat{x}ₙ, ŷₙ, \hat{z}ₙ) of the receiving end pointing to the scatterer and a unit vector (\hat{x}ₛₐₜ, ŷₛₐₜ, \hat{z}ₛₐₜ) of the receiving end pointing to the transmitting end can be calculated, and the angle αₙ can be calculated by the following equation:
$$\{ \begin{matrix}{\hat{x}}_{n} = cos {θ}_{n}^{a} cos {φ}_{n}^{a} \\ {\hat{y}}_{n} = cos {θ}_{n}^{a} sin {φ}_{n}^{a} \\ {\hat{z}}_{n} = sin {θ}_{n}^{a}\end{matrix} , \{ \begin{matrix}{\hat{x}}_{s a t} = cos {θ}_{s a t} cos {φ}_{s a t} \\ {\hat{y}}_{s a t} = cos {θ}_{s a t} sin {φ}_{s a t} \\ {\hat{z}}_{s a t} = sin {θ}_{s a t}\end{matrix}$$
$$cos {α}_{n} = \frac{{\hat{x}}_{n} {\hat{x}}_{sat} + {\hat{y}}_{n} {\hat{y}}_{sat} + {\hat{z}}_{n} {\hat{z}}_{sat}}{\vert ( {\hat{x}}_{n} , {\hat{y}}_{n} , {\hat{z}}_{n} ) \vert \vert ( {\hat{x}}_{sat} , {\hat{y}}_{sat} , {\hat{z}}_{sat} ) \vert}$$
and substituting αₙ in the first equation in Step S502, to obtain the central position (dₙ^{R}, φₙ^{a}, θₙ^{a}) of the cluster in the polar coordinates with the receiving end as the origin;
Step S503: calculating the geometric positions of the scatterers in each cluster, wherein the scatterers in the model are in a three-dimensional elliptical Gaussian distribution around the center of the cluster; the three dimensions of the scatterer follow a Gaussian distribution with a standard deviation of σₓ, σ_{y}, σ_{z}, and in the three-dimensional Cartesian coordinate system with the receiving end as the origin, the coordinates (xₙ_{ₘ}, yₙ_{ₘ}, zₙ_{ₘ}) of each scatterer are calculated by the following equation:
$$[ \begin{matrix}{x}_{{n}_{m}} \\ {y}_{{n}_{m}} \\ {z}_{{n}_{m}}\end{matrix} ] = [ \begin{matrix}cos ( {φ}_{n} ) & - sin ( {φ}_{n} ) & 0 \\ sin ( {φ}_{n} ) & cos ( {φ}_{n} ) & 0 \\ 0 & 0 & 1\end{matrix} ] \cdot [ \begin{matrix}cos ( {θ}_{n} ) & 0 & - sin ( {θ}_{n} ) \\ 0 & 1 & 0 \\ sin ( {θ}_{n} ) & 0 & cos ( {θ}_{n} )\end{matrix} ] \cdot [ \begin{matrix}{x}^{′} + {d}_{n}^{R} \\ {y}^{′} \\ {z}^{′}\end{matrix} ]$$
$$p ( {x}^{′} , {y}^{′} , {z}^{′} ) = \frac{exp ( - \frac{{x}^{′2}}{2 {σ}_{x}^{2}} - \frac{{y}^{′2}}{2 {σ}_{y}^{2}} - \frac{{z}^{′2}}{2 {σ}_{z}^{2}} )}{{( 2 π )}^{3 / 2} {σ}_{x} {σ}_{y} {σ}_{z}}$$
Step S504: calculating the path length d_{qp,n}_{ₘ}(t) and delay τ_{qp,n}_{ₘ}(t) of each path according to the geometric positions of the scatterers determined in Step S503, wherein the model needs to consider the delay resolution of subpaths, which is, with the changes of power in time domain and frequency domain taken into account, calculated as:
$${P}_{qp , {n}_{m} , {f}_{c}} ( t , f ) = exp ( - {τ}_{q p , {n}_{m}}^{′} ( t ) {g}_{{f}_{c}}^{D S} ) 1 {0}^{- \frac{{Z}_{n}}{10}} {( \frac{f}{{f}_{c}} )}^{γ}$$
where τ_{qp,n}_{ₘ}′(t) is a relative delay of each subpath, Zₙ is a cluster shadow calculated for each cluster, which follows a Gaussian distribution with a mean of 0;
$${( \frac{f}{{f}_{c}} )}^{γ}$$
models the frequency-dependent characteristic of power in a millimeter-wave high-bandwidth channel, and γ is related to frequency; g_{f}_{_{c}}^{DS} is a delay spread scale factor, which is, with different calculation methods employed in single-frequency point modeling and multi-frequency point modeling, expressed as:
$${g}_{{f}_{c}}^{D S} = \{ \begin{matrix}- 1.5 \cdot ln \{ 1.2 \cdot \frac{{DS}_{fc}}{max ( {DS}_{fc} ) + min ( {DS}_{fc} )} - 0.15 \} , & multiple frequency points \\ \frac{{r}_{τ} - 1}{{r}_{τ} DS} , & single frequency point\end{matrix}$$
where DS_{f}_{_{c}} denotes the large-scale parameters at different frequencies, DS is the delay spread, and r_{τ} is a delay distribution scale factor; and
Step S505: calculating the channel coefficient according to the generated parameters:
$$H = {[ PL \cdot SH \cdot {A}_{G} \cdot {A}_{R} ]}^{1 / 2} \cdot {h}_{qp , {f}_{c}} ( t , τ )$$
where, the large-scale fading [PL·SH·A_{G}·A_{R}]^{1/2} is calculated in Step 4, and the small-scale fading h_{qp,f}_{_{c}}(t, τ) is expressed as:
$${h}_{qp , {f}_{c}} ( t , τ ) = \sqrt{\frac{{K}_{R} ( t )}{{K}_{R} ( t ) + 1} {h}_{qp , {f}_{c}}^{L} ( t , τ )} + \sqrt{\frac{1}{{K}_{R} ( t ) + 1} {h}_{q p , {f}_{c}}^{N} ( t , τ )}$$
where, K_{R}(t) is the Rician K-factor that varies with time, h_{qp,f}_{_{c}}^{L}(t, τ) is the channel impulse response of a LOS path, and h_{qp,f}_{_{c}}^{N}(t,τ) is the channel impulse response of a NLOS path, respectively expressed as:
$${h}_{qp , {f}_{c}}^{L} ( t , τ ) = {[ \begin{matrix}{F}_{q , V} ( {ϕ}_{E , L}^{R} ( t ) , {ϕ}_{A , L}^{R} ( t ) ) \\ {F}_{q , H} ( {ϕ}_{E , L}^{R} ( t ) , {ϕ}_{A , L}^{R} ( t ) )\end{matrix} ]}^{T} \cdot [ \begin{matrix}{e}^{j {θ}_{L}^{VV}} & 0 \\ 0 & - {e}^{j {θ}_{L}^{HH}}\end{matrix} ] \cdot {F}_{r} \cdot [ \begin{matrix}{F}_{p , V} ( {ϕ}_{E , L}^{T} ( t ) , {ϕ}_{A , L}^{T} ( t ) ) \\ {F}_{p , H} ( {ϕ}_{E , L}^{T} ( t ) , {ϕ}_{A , L}^{T} ( t ) )\end{matrix} ] \cdot {e}^{j 2 π {f}_{c} {τ}_{qp}^{L} ( t )} δ ( τ - {τ}_{qp}^{L} ( t ) )$$
$${h}_{qp , {f}_{c}}^{N} ( t , τ ) = {\sum }_{n = 1}^{{N}_{qp} ( t )} {\sum }_{m = 1}^{{M}_{n} ( t )} {[ \begin{matrix}{F}_{q , {f}_{c} , V} ( {ϕ}_{E , {n}_{m}}^{R} ( t ) , {ϕ}_{A , {n}_{m}}^{R} ( t ) ) \\ {F}_{q , {f}_{c} , H} ( {ϕ}_{E , {n}_{m}}^{R} ( t ) , {ϕ}_{A , {n}_{m}}^{R} ( t ) )\end{matrix} ]}^{T} \cdot [ \begin{matrix}{e}^{j {θ}_{{n}_{m}}^{VV}} & \sqrt{{μκ}_{{n}_{m}}^{- 1} ( t )} {e}^{j {θ}_{{n}_{m}}^{VH}} \\ \sqrt{{κ}_{{n}_{m}}^{- 1} ( t )} {e}^{j {θ}_{{n}_{m}}^{HV}} & \sqrt{μ} {e}^{j {θ}_{{n}_{m}}^{HH}}\end{matrix} ] \cdot {F}_{r} \cdot [ \begin{matrix}{F}_{p , {f}_{c} , V} ( {ϕ}_{E , {n}_{m}}^{T} ( t ) , {ϕ}_{A , {n}_{m}}^{T} ( t ) ) \\ {F}_{p , {f}_{c} , H} ( {ϕ}_{E , {n}_{m}}^{T} ( t ) , {ϕ}_{A , {n}_{m}}^{T} ( t ) )\end{matrix} ] \cdot \sqrt{{P}_{qp , {n}_{m} , {f}_{c}} ( t )} \cdot {e}^{j 2 π {f}_{c} {τ}_{qp} , {n}_{m} ( t )} δ ( τ - {τ}_{qp , {n}_{m}} ( t ) )$$
where, [·]^{T} denotes transpose, F_{p(q),f}_{_{c}}_{,V} is a vertical polarization antenna pattern of the transmitting and receiving antennas, and F_{p(q),f}_{_{c}}_{,H} is an horizontal vertical polarization antenna pattern; κₙ_{ₘ}(t) is a cross-polarization ratio, μ denotes co-polarization imbalance, ϕ_{A,L}^{T}(t) is an azimuth angle of departure corresponding to the LOS path at the moment t stretching from A₁^{T} to A₁^{R}, ϕ_{E,L}^{T} (t) is an elevation angle of departure corresponding to the LOS path at the moment t stretching from A₁^{T} to A₁^{R}, ϕ_{A,L}^{R}(t) is an azimuth angle of arrival corresponding to the LoS path at the moment t stretching from A₁^{T} to A₁^{R}, ϕ_{E,L}^{R}(t) is an elevation angle of arrival corresponding to the LoS path at the moment t stretching from A₁^{T} to A₁^{R}, θ_{L}^{VV} and θ_{L}^{HH} represent the initial phases of the LOS path, θₙ_{ₘ}^{HH}, θₙ_{ₘ}^{HV}, θₙ_{ₘ}^{VV} and θₙ_{ₘ}^{VH} represent the initial phases of the NLOS path, which are random variables that follow a uniform distribution between 0 and 2π; Faraday rotation matrix Fᵣ refers to the rotation of a polarization plane caused by the propagation of electromagnetic waves through the ionosphere in the satellite scenario, which needs to be considered in communication scenarios below 10 GHZ; P_{qp,n}_{ₘ}_{,f}_{_{c}}(t) is the subpath power calculated in Step S504, τ_{qp}^{L}(t) is the absolute delay of the Mth of LOS subpath of LOS, which can be calculated by dividing the distance between the transmitting and receiving antennas q, p by the speed of light, and τ_{qp,n}_{ₘ}(t) is the absolute delay of the Mth subpath in the Nth cluster, which can be calculated by dividing the length of the nₘth subpath between the transmitting and receiving antennas q, p by the speed of light.

7. The satellite communication-oriented geometry-based stochastic channel modeling method according to claim 6, wherein the step S6 specifically comprises the following steps:
Step S601: introducing a survival probability Pₛᵤᵣᵥ(Δt, Δf) of the cluster in the time-frequency domain, with the birth and death of the cluster in the time domain and frequency domain taken into account:
$${P}_{surv} ( Δ t , Δ f ) = {P}_{surv} ( Δ t ) \cdot {P}_{surv} ( Δ f ) = {e}^{- {λ}_{R} \frac{{v}_{r x} Δ t}{{D}_{c}^{T}}} \cdot {e}^{{- {λ}_{R} \frac{Δ t}{{D}_{c}^{F}}}_{}}$$
where, Pₛᵤᵣᵥ(Δt) is the time-domain cluster survival probability, Pₛᵤᵣᵥ(Δf) is the frequency-domain cluster survival probability, Δt is a time interval, Δf is a frequency interval, the birth-death process of the cluster is described jointly by a generation rate λ_{G} and a disappearance rate λ_{R} of the cluster, these two parameters are related to the environmental characteristics of the communication scenario and the antenna pattern; parameters D_{c}^{T}, D_{c}^{F} are scenario-related factors in the time domain and frequency domain, obtained by channel measurement in a specific scenario; and an expected number [symbol] {N_{new}} of new clusters is calculated as; and
$$𝔼 \{ {N}_{n e w} \} = \frac{{λ}_{G}}{{λ}_{R}} [ 1 - {P}_{surv} ( Δ t , Δ f ) ]$$
Step S602: updating the channel coefficient according to the step S5, with the movement of the transmitting and receiving ends and the clusters as well as the birth and death of the clusters taken into account.

8. The satellite communication-oriented geometry-based stochastic channel modeling method according to claim 7, wherein the step S7 specifically comprises:
Step S701: calculating an effective path loss, which consists of three parts: free path loss PL, atmospheric absorption A_{G} and rainfall attenuation A_{R}, wherein the three large-scale fading components do not change rapidly with time, showing a relatively constant trend, and the sum of the three is defined as the effective path loss: PL_{eff}=PL+A_{G}+A_{R}
Step S702: calculating the root-mean-square (RMS) delay spread of the channel, expressed as:
$${D}_{qp , rms} ( t ) = \sqrt{\frac{{\int }_{- ∞}^{∞} {( τ - {μ}_{qp , τ} ( t ) )}^{2} {P}_{qp , {n}_{m} , {f}_{c}} ( t , τ ) d τ}{{\int }_{- ∞}^{∞} {P}_{qp , {n}_{m} , {f}_{c}} ( t , τ ) d τ}}$$
where, τ is the delay, and the average delay can be expressed as:
$${μ}_{qp , τ} ( t ) = \frac{{\int }_{- ∞}^{∞} τ \cdot {P}_{qp , {n}_{m} , {f}_{c}} ( t , τ ) d τ}{{\int }_{- ∞}^{∞} {P}_{qp , {n}_{m} , {f}_{c}} ( t , τ ) d τ} ;$$
Step S703: calculating a time-frequency correlation function of the channel, with a theoretical value expressed as:
$${R}_{q p} ( t , f ; Δ t , Δ f ) = 𝔼 [ {H}_{q p} ( t , f ) {H}_{q p}^{*} ( t + Δ t , f + Δ f ) ]$$
where, [symbol] [·] represents the expectation, [·]* represents the conjugate of a complex number, H_{qp} represents a channel transfer function, which is obtained by Fourier transform of the channel impulse response; without considering the correlation between the LOS path and the NLOS path, the time-frequency correlation function is expressed as the sum of the time-frequency correlation functions of the paths:
$${R}_{q p} ( t , f ; Δ t , Δ f ) = {R}_{q p}^{L} ( t , f ; Δ t , Δ f ) + {R}_{q p}^{N} ( t , f ; Δ t , Δ f )$$
where, R_{qp}^{L}(t, f; Δt, Δf) represents the time-frequency correlation function of the LOS path, expressed as:
$${R}_{q p}^{L} ( t , f ; Δ t , Δ f ) = 𝔼 [ \sqrt{\frac{{K}_{R} ( t )}{{K}_{R} ( t ) + 1} \cdot \frac{{K}_{R} ( t + Δ t )}{{K}_{R} ( t + Δ t ) + 1}} {e}^{j 2 π ( \frac{( {f}_{c} - f ) {d}_{q p} ( t ) - ( {f}_{c} - f - Δ f ) d q p}{c} ( t + Δ t )} ) ]$$
where, c is the speed of light;
R_{qp}(t, f; Δt, Δf) represents the time-frequency correlation function of the NLOS path, and without considering the correlation between multipaths, is expressed as:
$${R}_{q p}^{N} ( t , f ; Δ t , Δ f ) = {P}_{surv} ( Δ t , Δ f ) \cdot 𝔼 [ {\sum }_{m = 1}^{M} {\sum }_{n = 1}^{N} \sqrt{{P}_{qp , {n}_{m ,} {f}_{c}} ( t , f ) {P}_{qp , {n}_{m} , {f}_{c}} ( t + Δ t , f + Δ f )} \cdot {e}^{j 2 π ( \frac{( {f}_{c} - f ) {d}_{qp ,} {n}_{m} ( t ) - ( {f}_{c} - f - Δ f ) {d}_{qp} , {n}_{m} ( t + Δ t )}{c} )} ]$$
Step S704: calculating the Doppler frequency of each multipath:
$${v}_{qp , {n}_{m}} ( t ) = - \frac{{v}^{T}}{λ} cos ( {ω}_{p}^{T} ) - \frac{{v}^{R}}{λ} cos ( {ω}_{q}^{R} ) + \frac{{sin}^{2} ( {ω}_{p}^{T} ) {( {v}^{T} )}^{2} t}{λ ( {d}_{{n}_{m}}^{T} - cos ( {ϑ}^{T} ) {δ}_{p} )} + \frac{{sin}^{2} ( {ω}_{q}^{R} ) {( {v}^{R} )}^{2} t}{λ ( {d}_{{n}_{m}}^{R} - cos ( {ϑ}^{R} ) {δ}_{q} )}$$
where, δₚ and δ_{q} in the equation represent the antenna spacings at the transmitting end and the receiving end respectively, ωₚ^{T} represents an angle between the moving direction of the transmitting end and the nₘth path corresponding to the pth transmitting antenna, ω_{q}^{R} represents an angle between the moving direction of the receiving end and the nₘth path corresponding to the qth receiving antenna, and ϑ^{T} represents an angle between the transmitting antenna array and the nₘth path corresponding to the 1st transmitting antenna; and by calculating the Doppler frequencies corresponding to all multipaths in each simulation, local Doppler spread under this simulation can be obtained, and through multiple simulations to obtain the sample mean, local Doppler spread under this type of scenario can be obtained:
$${B}_{q p}^{( 2 )} ( t ) = 𝔼 [ \sqrt{\overline{[ {{v}_{qp , {n}_{m}} ( t )}^{2} ]} - \overline{{[ {v}_{qp , {n}_{m}} ( t ) ]}^{2}}} ] .$$
